(19) United States
(12) Patent Application Publication
(10) Pub. No.: US 2018/0013832 A1
(43) Pub. Date: Jan. 11, 2018

(54) HEALTH DEVICE, GATEWAY DEVICE AND METHOD FOR SECURING PROTOCOL USING THE SAME

(71) Applicant: ELECTRONICS AND TELECOMMUNICATIONS RESEARCH INSTITUTE, Daejeon (KR)

(72) Inventors: Sok-Joon LEE, Sejong (KR); Hyeok-Chan KWON, Daejeon (KR); Gae-Il AN, Daejeon (KR); Do-Young CHUNG, Daejeon (KR); Byung-Ho CHUNG, Daejeon (KR)

(21) Appl. No.: 15/638,133

(22) Filed: Jun. 29, 2017

(30) Foreign Application Priority Data
Jul. 11, 2016 (KR) 10-2016-0087299

(51) Int. Cl. H04L 29/08; H04W 12/02; H04L 29/06; G06F 19/00; H04W 12/08; G06Q 50/22

(52) U.S. Cl. CPC H04L 67/12; H04L 63/1441; G06F 19/322; H04W 12/02; G06Q 50/22; H04W 12/08

(57) ABSTRACT

Disclosed herein are a health device, a gateway device, and a method for securing a protocol using the health device and the gateway device. The method includes performing, by the health device and the gateway device, authentication and key exchange based on security session information; sending, by any one of the health device and the gateway device, an application message protected based on the security session information; and receiving, by a remaining one of the health device and the gateway device, the protected application message.

### CROSS REFERENCE TO RELATED APPLICATION

This application claims the benefit of Korean Patent Application No. 10-2016-0087299, tiled Jul. 11, 2016, which is hereby incorporated by reference in its entirety into this application.

### BACKGROUND OF THE INVENTION

### 1. Technical Field

The present invention relates generally to technology for transferring data between a health device and a gateway device; and more particularly to security technology for a protocol based on IEEE 11073-20601, which is a standard for a data transfer protocol for health devices.

### 2. Description of the Related Art

Recently, with the advent of an aged society, the number of senior citizens who live alone is increasing, and the goal of medical service is changing from treatment to prevention. Accordingly, there is growing interest in a telemedicine service through which a person may check his or her health without the need to visit a clinic.

Such a telemedicine service requires a device for accurately measuring personal health data, such as the blood pressure, the weight, the blood-sugar level, and the like, and a device for delivering data, collected from the measurement device, to a medical information system or another kind of personal health care service.

A device for measuring personal health data and sending the measured health data to a data collection device via a wired or wireless network in Larder to Make use of the data in various kinds of services is called a “smart health device”.

The IEEE 11073-20601 protocol is a standard for providing interoperability when personal health data are sent and received between a smart health device agent) and a gateway (manager) corresponding to a data collection device. The IEEE 11073-20601 standard defines a data representation model, a service model for accessing data of a device, a communication model for data exchange, and the like from the aspect of delivering personal health data measured by a smart health device.

Because personal health data are sensitive data related to personal privacy, the data must be prevented from being exposed to other people when transmitted. Also, considering the reliability of a personal healthcare service and interconnection with medical systems in the future, it is very important to prevent the measured data from being falsified while being transmitted. However, the IEEE 11073-20601 includes no security mechanism, and the security thereof depends fully upon security provided in a lower transport layer that is responsible for the transmission of data. That is, any security vulnerability present in the transport layer may cause a serious problem that adversely affects the security, privacy, and reliability of data transmitted according to the IEEE 11073-20601 protocol.

Meanwhile, Korean Patent No. 10-1474252, titled “Authentication method and system for IEEE 11073 agent” relates to a method and system for enabling an IEEE 11073 manager to authenticate an agent. The method is configured such that, when an IEEE 11073 manager stores a secret key and when an IEEE 11073 agent stores an authentication seed generated using the secret key, the IEEE 11073 manager receives authentication code, generated using the authentication seed by the IEEE 11073 agent, therefrom and authenticates the authentication code using the secret key.

However, Korean Patent No. 10-1474252 has a limitation in that a previously stored secret key is used, and does not mention a method for securing the transmission and reception of application messages after authentication between an IEEE 11073 agent and an IEEE 11073 manager is completed.

### SUMMARY OF THE INVENTION

An object of the present invention is to provide security independently of a transport layer by modifying the configuration of the IEEE 11073-20601 protocol in order to solve the above problems with the conventional art.

Another object of the present invention is to provide mutual authentication and key exchange in which confidentiality and integrity are guaranteed in a protocol, a message protection function, and a state machine in which a security layer is separate from other layers in order to provide security independently of a transport layer.

A further object of the present invention is to guarantee the security, privacy, and reliability of data transmitted according to the IEEE 11073-20601 protocol.

In order to accomplish the above objects, a method for securing a protocol using a health device and a gateway device according; to an embodiment of the present invention includes performing, by the health device and the gateway device, authentication and key exchange based on security session information; sending, by any one of the health device and the gateway device, an application message protected based on the security session information; and receiving, by a remaining one of the health device and the gateway device, the protected application message.

Here, the security session information may include cipher suites, in which a combination of encryption algorithms to be used varies depending on a security level.

Here, the encryption algorithms may correspond to one or more of a Pre-Shared Key (PSK) encryption algorithm, an Elliptic Curve Diffie-Hellman Ephemeral (ECDHE)-PSK encryption algorithm, Advanced Encryption Standard (AES), Message-Digest algorithm 5 (MD5), and Secure Hash Algorithm (SHA).

Here, performing the authentication and the key exchange may include sending, by the health device, an Application Association. ReQuest (AARQ) in which security session information is included to the gateway device; receiving, by the health device, an Application Association REsponse (RARE) to which a session ID is assigned based on the security session information by the gateway device; sending, by the health device, an AARQ in which an agent_finished message, generated based on the AARE, is included to the gateway device; sending, by the gateway device, an AARE in which a manager finished message, generated based on the AARQ including the agent finished message, is included to the health device; and checking whether the authentication and the key exchange have succeeded in such a way that each of the health device and the gateway device compares the manager_finished message with the agent_finished message.

Here, performing the authentication and the key exchange may be configured to generate a premaster secret using a PSK when the authentication and the key exchange are performed based on the PSK encryption algorithm, and to generate the premaster secret using the PSK and temporary agent public key and temporary manager public key based on an ECDHE-PSK when the authentication and the key exchange are performed based on the ECDHE-PSK encryption algorithm.

Here, the premaster secret may be configured with an octet string having a length that is equal to a sum of a length of other_secret and a length of the PSK.

Here, the length of the other secret may be equal to the length of the PSK when the authentication and the key exchange are performed based on the PSK encryption algorithm; and the length of the other secret may be equal to a length of an octet string corresponding to a coordinate value of a point on an elliptic curve based on the temporary agent public key and the temporary manager public key when the authentication and the key exchange are performed based on the ECDHE-PSK encryption algorithm.

Here, performing the authentication and the key exchange may be configured to generate a master secret by applying the generated premaster secret to a Pseudo Random Function (PRF).

Here, performing the authentication and the key exchange may be configured to generate a ‘Finished’ message using the PRF based on the generated master secret and the security session information.

Here, performing the authentication and the key exchange may be Configured to generate a key block, which is separated into a Message Authentication Code (MAC) secret and an encryption key, by applying the master secret to the PRF, wherein a length of the key block is determined based on a cipher suite that is used.

Here, performing the authentication and the key exchange may be configured such that the gateway device compares a manager_finished message, generated by the gateway device based on a PSK identity received from the health device, with an agent_finished message, received from the health device; the gateway device sends the manager_finished message to the health device when it is determined that the manager_finished message is identical to the agent_finished message as a result of comparison; the health device compares the agent_finished message with the received manager_finished message; and the authentication and the key exchange are determined to have succeeded when the health device determines that the agent_finished message is identical to the received manager_finished message as a result of comparison.

Here, in performing the authentication and the key exchange, an Application Association ReQuest (AARQ) and an Application Association REsponse (AARE), sent and received by the health device and the gateway device, may be configured such that ‘secureassoc’, which is a message for a security protocol, is defined in ‘FunctionalUnits’ of ‘PhdAssociationinformation’.

Here, the AARQ and the AARE may be configured such that the Security session information is defined in ‘option-list’ of ‘PhdAssociationInformation’.

Here, the protected application message may be configured such that Secure Presentation (secprst) is defined in Application Protocol Data Unit Type (ApduType).

Here, sending the protected application message may include generating a MAC using the MAC secret; adding the MAC to the application message; encrypting the application message using the encryption key and an initial vector; and sending the encrypted application message.

Here, generating the MAC may be configured to generate the MAC by applying the MAC secret to a Hash-based Message Authentication Code (HMAC) function.

Here, adding the MAC may be configured to add padding to the application message to which the MAC is added when a length of the application message to which the MAC is added is not a multiple of a block length of the encryption algorithm that is used.

Here, encrypting the application message may be configured to encrypt the application message using the initial vector having a length that is equal to a block length of the encryption algorithm.

Here, receiving the protected application message may include checking a sequence number of the received application message; decrypting the application message using the encryption key; verifying the MAC, isolated from the decrypted application message, using the MAC secret; and delivering the application message to an upper layer when the isolated MAC is verified.

Here, a state machine of the health device and the gateway device may be configured such that the security session information is processed in a security layer that is separate from a lower layer, and the received application message is decrypted in the security layer and is then delivered to an upper layer.

Also, in order to accomplish the above objects, a health device according to an embodiment of the present invention includes a communication unit fir sending and receiving a message to and from a gateway device; a message generation unit for generating an Application Association ReQuest (AARQ) based on security session information; an authentication unit for performing authentication and key exchange based on the AARQ and an Application Association REsponse (AARE) received from the gateway device; a protection unit for securing an application message to be sent to the gateway device based on the security session information; and a decryption unit for decrypting a secured application message received from the gateway device.

Here, a state machine of the health device may be configured such that the security session information is processed in a security layer separate from a lower layer, and an application message received from the gateway device is decrypted in the security layer and is then delivered to an upper layer.

Also, in order to accomplish the above objects, a health device according to an embodiment of the present invention includes a communication unit for sending and receiving a message to and from a health device; a message generation unit for generating an Application Association REsponse (AARE) based on security session information of an Application Association ReQuest (AARQ) received from the health device; an authentication unit for performing authentication and key exchange based on the AARQ and the AARE; an encryption unit for securing an application message to be sent to the health device based on the security session information; and a decryption unit for decrypting a secured application message received from the health device.

Here, a state machine of the gateway device may be configured such that the security session information is processed in a security layer separate from a lower layer, and an application message received from the health device is decrypted in the security layer and is then delivered to an upper layer.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart that shows a method for securing a protocol according, to an embodiment of the present invention;

FIG. 2 is a flowchart that specifically shows an example of the authentication and key exchange step illustrated in FIG. 1;

FIG. 3 is a table that shows cipher suites including encryption algorithms, which are defined differently depending on the security level according to an embodiment of the present invention;

FIG. 4 is a table that shows security session information sent by a health device (agent) in a complete authentication process according to an embodiment of the present invention;

FIG. 5 is a table that shows security session information sent by a health device (agent) in a simplified authentication process according to an embodiment of the present invention;

FIG. 6 is a table that shows security session information sent by a gateway device (manager) in a complete authentication process according to an embodiment of the present invention;

FIG. 7 is a table that shows security session information sent by a gateway device (manager) in a simplified authentication process according to an embodiment of the present invention;

FIG. 8 is a flowchart that specifically shows an example of the step of sending an Application Association ReQuest (AARQ) including an agent finished message, illustrated in FIG. 2;

FIG. 9 is a table that shows information included in a key block that is generated from a master secret according to an embodiment of the present invention;

FIG. 10 is a table that shows information about an AARQ including an agent finished message, sent by a health device (agent), according to an embodiment of the present invention;

FIG. 11 is a flowchart that specifically shows an example of the step of receiving an Application Association REsponse (AARE) including a manager finished message, illustrated in FIG. 2;

FIG. 12 is a table that shows information about an AARE including a manager finished message, sent by a gateway device (manager), according to an embodiment of the present invention;

FIG. 13 is a sequence diagram that shows an authentication and key exchange process in a complete authentication process according to an embodiment of the present invention;

FIG. 14 is a sequence diagram that shows an authentication and key exchange process in a simplified authentication process according to an embodiment of the present invention;

FIGS. 15 to 18 are views that show an AARQ and an AARE, in each of which security session information is inserted, according to an embodiment of the present invention;

FIG. 19 is a sequence diagram that shows an authentication and key exchange process using an AARQ and an AARE according to an embodiment of the present invention;

FIG. 20 is a flowchart that specifically shows an example of the step of sending an application message, illustrated in FIG. 1;

FIG. 21 is a table that shows information necessary for the protection of an application message according to an embodiment of the present invention;

FIG. 22 is a view that shows the process of encrypting an application message according to an embodiment of the present invention;

FIG. 23 is a flowchart that specifically shows an example of the step of receiving an application message, illustrated in FIG. 1;

FIG. 24 is a block diagram that shows a state machine according to an embodiment of the present invention;

FIG. 25 is a table that shows state information used in the security layer of a state machine according to an embodiment of the present invention;

FIG. 26 is a table that shows event information used in the security layer of a state machine according to an embodiment of the present invention;

FIGS. 27 to 30 are tables that show transition information used in the security layer of a state machine of a health device;

FIGS. 31 to 34 are tables that show transition information used in the security layer of a state machine of a gateway device;

FIG. 35 is a block diagram that shows a health device according to an embodiment of the present invention;

FIG. 36 is a diagram that shows a state machine of a health device according to an embodiment of the present invention;

FIG. 37 is a block diagram that shows a gateway device according to an embodiment of the present invention;

FIG. 38 is a diagram that shows a state machine of a gateway device according to an embodiment of the present invention; and

FIG. 39 is a block diagram that shows a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obsecure will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment of the present invention will be described in detail with reference to the accompanying drawings.

The present invention may configure a security protocol for securing the protocol defined in IEEE 11073-20601. To this end, the present invention may be designed with reference to PSK-TLS (RFC 4279, Pre-Shared Key cipher suites for Transport Layer Security (TLS)). Here, PSK-TLS is an IETF RFC standard for TLS protocol version 1.0 (RFC 2246) for communication using a pre-shared key, and specifies the extension of the TLS handshake protocol along with the total of twelve cipher suites.

In the present invention, a security protocol for the IEEE 11073-20601 protocol may be designed by applying relevant standards, such as PSK-TLS, TLS 1.0, 1.1, and 1.2, and the like. Using the relevant standards, cipher suites that takes into consideration hardware, an authentication and key-exchange protocol, which corresponds to the TLS handshake protocol, a message protection protocol, which corresponds to the TLS record protocol and is responsible the authentication and encryption of messages, and the like may be defined.

In a medical environment in which the security protocol is to be used, it is necessary to appropriately classify security levels depending on the hardware level of health devices and the application service environment. For example, when authentication and key exchange are performed, if Perfect Forward Secrecy (PFS) is required for a higher security level than when PSK-based authentication is used, Diffie-Hellman (DH) key exchange may be needed.

However, it is difficult to use such a technique in a health device having low hardware performance. Accordingly, in the present invention, an encryption algorithm based on DH key exchange is excluded, but an encryption algorithm based on Elliptic Curve Diffie-Hellman Ephemeral (ECDHE) may be used for authentication and key exchange.

In the present invention, encryption algorithms selected in consideration of the security thereof may be categorized into an encryption algorithm for authentication and key exchange, an encryption algorithm for message protection, and an encryption algorithm for cryptographic hash functions (for the generation of a key or for Message authentication code), with reference to TLS protocols version 1.0 (RFC 2246), Version 1.1 (RFC 4346), and version 1.2 (RFC 5246), ECC cipher suites for TLS (RFC 4492), the PSK-TLS protocol (RFC 4279), ECDHE-PSK cipher suites for TLS (RFC 5489), HMAC (RFC 2104), and the like.

First, for authentication and key exchange, a PSK-based encryption algorithm and an encryption algorithm based on ECDHE-PSK may be used.

The PSK-based encryption algorithm is similar to the “PSK Key Exchange Algorithm” released in section 2 of RFC 4279, and may be used when mutual authentication and key exchange are performed using only a Pre-Shared Key (PSK) without the use of a public-key-based algorithm.

Here, the PSK-based encryption algorithm is fast but may not provide Perfect Forward Secrecy (PFS).

The encryption algorithm based on ECDHE-PSK is similar to RFC 5489, and is configured such that mutual authentication and key exchange can be performed using an ephemeral key, derived from an ECDHE-based key exchange algorithm, and a PSK.

Here, the encryption algorithm based on ECDHE-PSK is slower than the method using only a PSK, but is faster than RSK_PSK and DHE_PSK. Also, the encryption algorithm based on ECDHE-PSK is suitable for a low power device, and may provide Perfect Forward Secrecy (PFS).

Also, in the encryption algorithm based on ECDHE-PSK, the speed and security strength thereof may be adjusted depending on the elliptic curve that is used.

Second, for message encryption, Advanced Encryption Standard (AES)-128 and AES-256 algorithms may be used.

The AES-128 algorithm may be used to encrypt a 128-bit message block using a 128-bit key. This algorithm is not used in TLS version 1.0, published in 1999, but RFC 3268 (AES Cipher suites for TLS) has defined cipher suites using AES-128 and AES-756.

The AES-256 algorithm may be used to encrypt a 128-bit message block using a 256-bit key.

Third, for cryptographic hash functions (for the generation of a key or for message authentication code), Message-Digest Algorithm 5 (MD5), Secure Hash Algorithm 1 (SHA1). and SHA-256 may be used.

MD5 and SHA1 are hash algorithms for respectively generating a 128-bit hash value and a 160-bit hash value for an arbitrary memory block, and may be used for a Pseudo Random Function (PRF) (internally uses HMAC) and Hash-based Message Authentication Code (HMAC), wherein the PRF is used for generating a key, and HMAC is used for generating message authentication code. In TLS version 1.0 and version 1.1, both MD5 and SHA-1 may be used as a hash algorithm inside a PRF.

Here, MD5 and SHA-1 are known to be vulnerable to collision attacks, but the vulnerability of HMAC using MD5 or SHA-1 to collision attacks is not yet known.

SHA-256 is a hash algorithm for generating a 256-bit hash value for an arbitrary message block, and may be used as a hash algorithm of the PRF in TLS version 1.2 and versions released subsequent thereto.

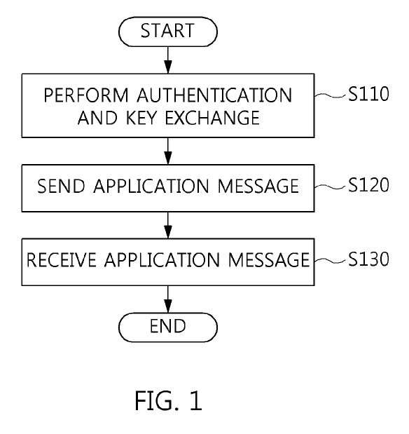

FIG. 1 is a flowchart that shows a method for securing a protocol according to an embodiment of the present invention.

Referring to FIG. 1, in the method for securing a protocol according to an embodiment of the present invention, first, authentication and key exchange are performed at step S110.

That is, at step S110, based on information about a security session between a health device 200 and a gateway device 300, authentication and key exchange may be performed using an encryption algorithm.

Here, at step S110, based on information about a session between the health device 200 and the gateway device 300, authentication and key exchange may be performed according to any one of a complete authentication process and a simplified authentication process.

Here, the health device 200 and the gateway device 300 determine whether authentication and key exchange have succeeded at step S110, and they may send and receive application messages when it is determined that mutual authentication has succeeded.

Also, in the method for securing a protocol according to an embodiment of the present invention, an application message may be sent at step S120.

That is, at step S120, any one of the health device 200 and the gateway device 300, which have performed mutual authentication and key exchange, may encrypt an application message and send the encrypted application message.

Here, at step S120, the health device 200 may encrypt an application message and send it to the gateway device 300, or the gateway device 300 may encrypt an application message and send it to the health device 200.

Also, in the method for securing a protocol according to an embodiment of the present invention, an application message may be received at step S130.

That is, at step S130, any one of the health device 200 and the gateway device 300 may receive an application message and decrypt the received application message.

Here, at step S130, whether the decrypted application message is valid is checked, and the decrypted application message may be delivered to an upper layer of a state machine when the verification has succeeded.

Hereinafter, the detailed steps of a method for securing a protocol according to an embodiment of the present invention will be described.

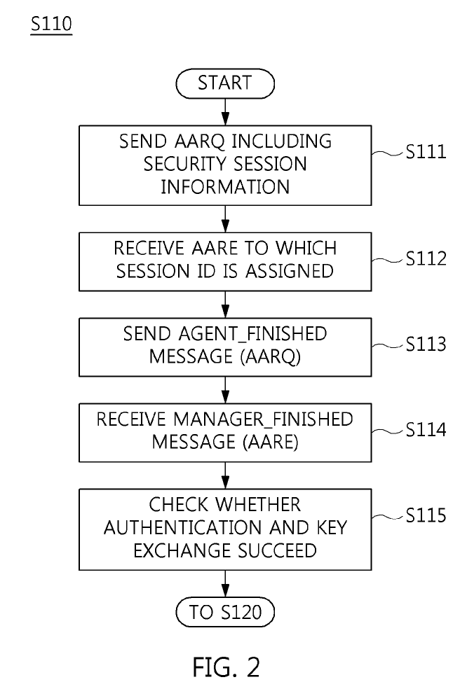

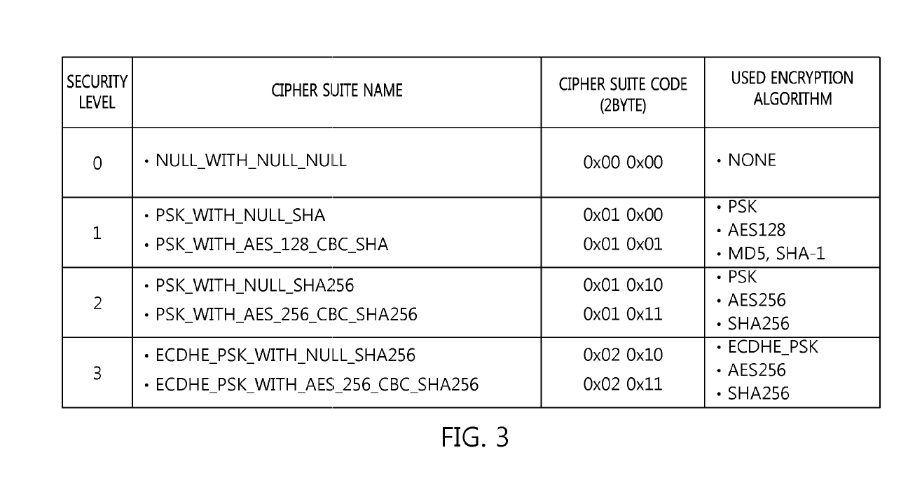

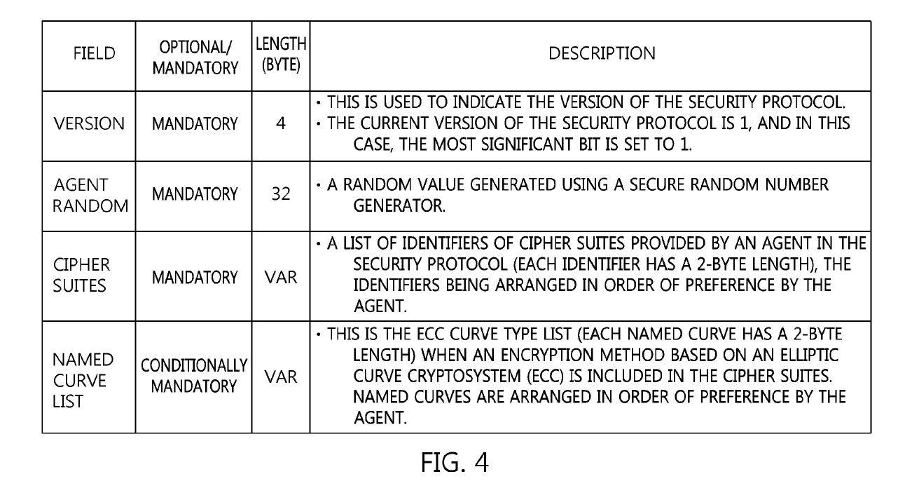

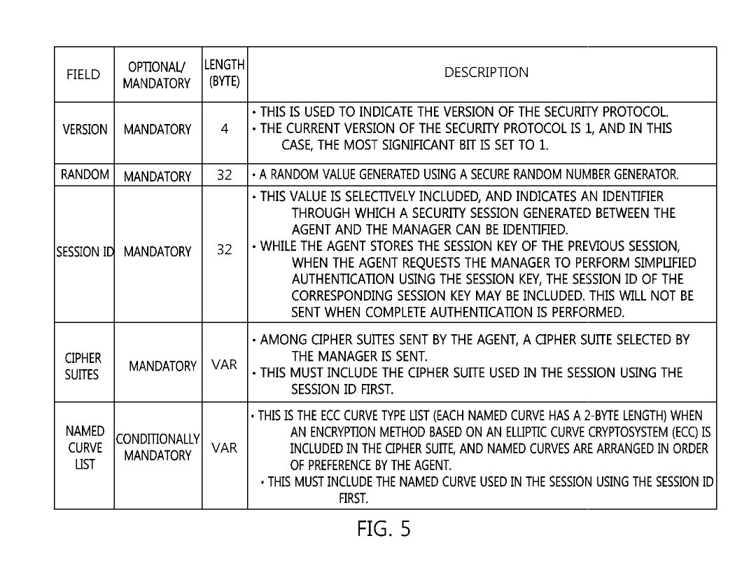

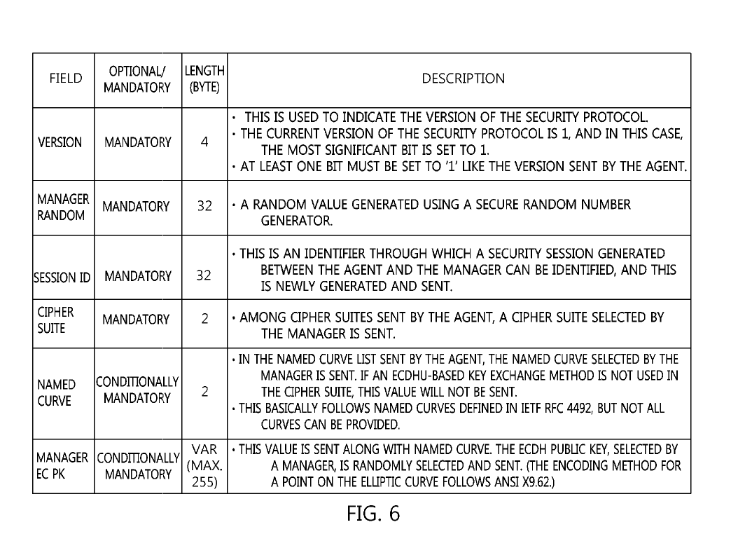

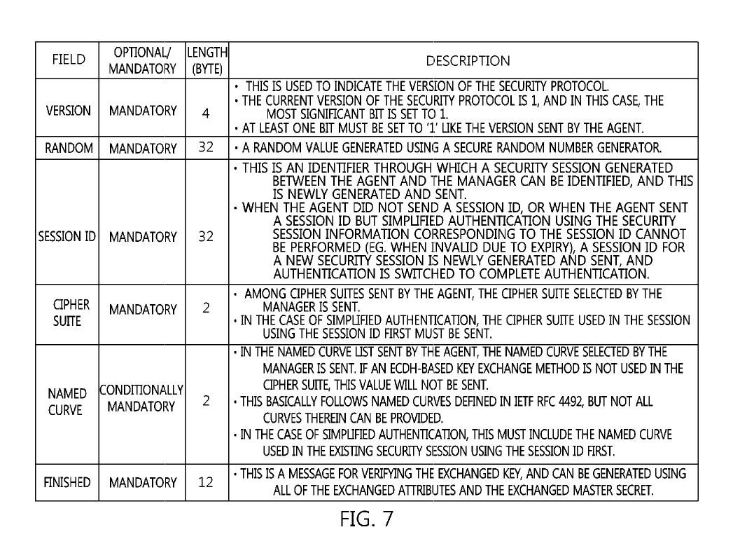

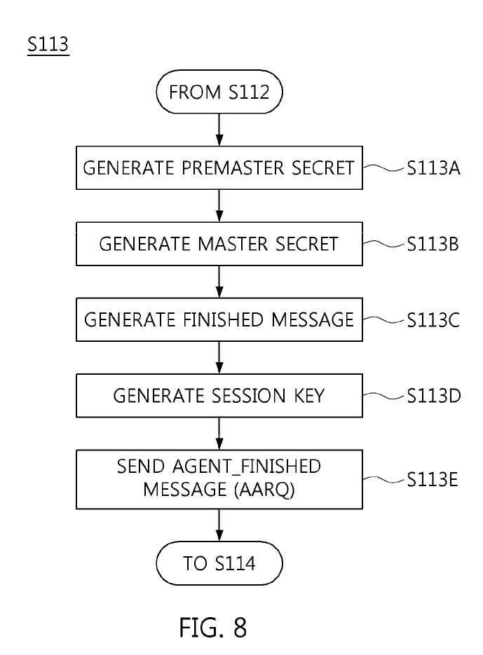

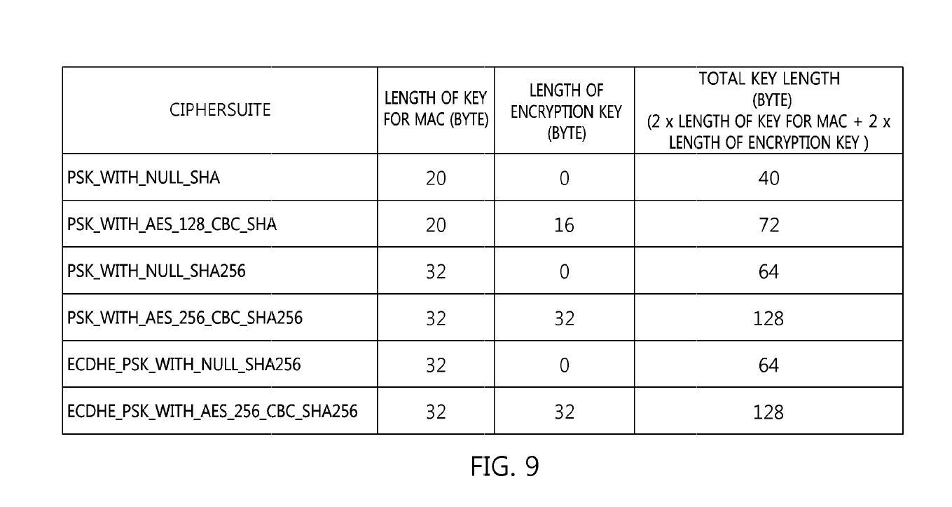

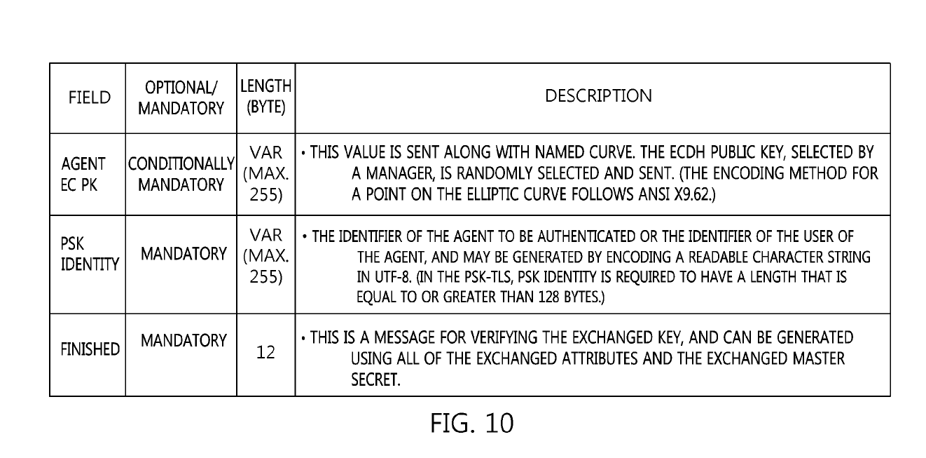

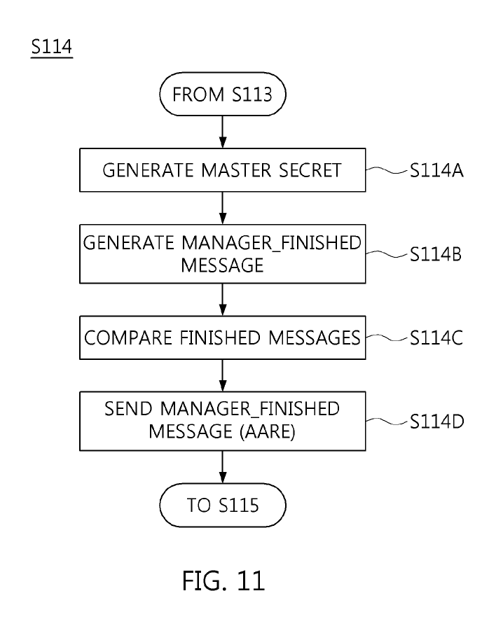

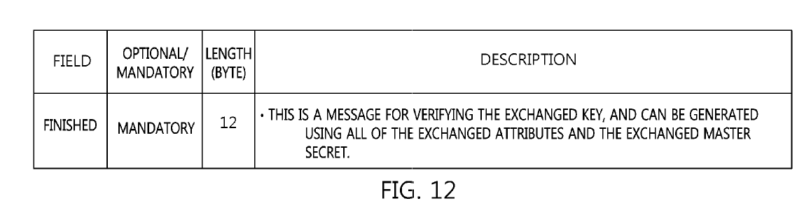

FIG. 2 is a flowchart that specifically shows an example of the authentication and key exchange step illustrated in FIG. 1. FIG. 3 is a table that shows cipher suites including encryption algorithms, which are defined differently depending on the security level, according to an embodiment of the present invention. FIG. 4 is a table that shows security session information sent by a health device (agent) in a complete authentication process according to an embodiment of the present invention. FIG. 5 is a table that shows security session information sent by a health device (agent) in a simplified authentication process according to an embodiment of the present invention. FIG. 6 is a table that shows security session information sent by a gateway device (manager) in a complete authentication process according to an embodiment of the present invention. FIG. 7 is a table that shows security session information sent by a gateway device (manager) in a simplified authentication process according to an embodiment of the present invention. FIG. 8 is a flowchart that specifically shows an example of the step of sending an AARQ including an agent_finished Message, illustrated in FIG. 2 FIG. 9 is a title that shows information included in a key block that is generated from a master secret according to an embodiment of the present invention. FIG. 10 is a table that shows information about an AARQ including an agent_finished message, sent by a health device (agent), according to an embodiment of the present invention. FIG. 11 is a flowchart that specifically shows an example of the step of receiving an AARE including a manager_finished message, illustrated in FIG. 2. FIG. 12 is a table that shows information about an AARE including a manager_finished message, sent by a gateway device (manager), according to an embodiment of the present invention.

Referring to FIG. 2, at step S110, first, an AARQ including security session information may be sent at step S111.

That is, at step S111, the health device 200 may send the gateway device 300 an Application Association ReQuest (AARQ) in which security session information is included.

The security session information may include cipher suites in which a combination of encryption algorithms to be used is defined differently depending on the security level.

FIG. 3 shows cipher suites including different encryption algorithms, which are selected depending on the security level, according to an embodiment of the present invention.

Because the health device 200 and the gateway device 300 have relatively low computational capability compared to a server environment on the Internet in which TLS is used, various combinations of cipher suites defined in TLS may not be provided.

Accordingly, security levels are classified depending on the hardware level of a health device and a service environment, and cipher suites based on a security level may be defined as shown in FIG. 3.

The code value of a cipher suite is a 2-byte value defined independently of TLS, and may be configured such that the first byte thereof corresponds to security technology to be used for authentication and key exchange and the second byte thereof corresponds to security technology to be used for the protection of a message after authentication is performed.

In the security level 0, there is no encryption algorithm to be used. In the security level 1, PSK, AES-128, MD5, and SHA-1 may be used. In the security level 2, PSK, AES-256, and SHA-256 may be used. In the security level 3, ECDHE-PSK, AES-256, and SHA-255 may be used.

At step S111, the AARQ to be sent may vary depending on whether an authentication process follows complete authentication or simplified authentication.

Complete authentication may be performed when the health device 200 and the gateway device 300 perform authentication for the first time or when existing security session information cannot be used anymore.

Simplified authentication may be performed when existing security session information is maintained between the devices and when a validity time has not passed.

FIG. 4 shows security session information to be sent by the health device 200 when complete authentication is performed according to an embodiment of the present invention,

That is, at step S111, when complete authentication is performed, the health device 200 may send an AARQ including the security session information illustrated in FIG. 4 to the gateway device 300.

FIG. 5 shows security session information to be sent by the health device 200 when simplified authentication is performed according to an embodiment of the present invention.

As illustrated in FIG. 5, when simplified authentication is performed, the security session information, included in an AARQ to be sent by the health device 200, includes a session ID because session information remains in the health device 200.

That is, at step S111, when simplified authentication is performed, the health device 200 may send an AARQ including the security session information illustrated in FIG. 5 to the gateway device 300.

Also, at step S110, an AARE to which a session ID is assigned may be received at step S112.

That is, at step S112, the health device 200 may receive an Application Association REsponse (AARE), to which a session ID based on the security session information of the received AARQ is assigned by the gateway device 300, from the gateway device 300.

Here, at step S112, when complete authentication is performed, the health device 200 may receive an AARE, in which a session ID is assigned to security session information, from the gateway device 300.

Specifically, at step S112, first, the gateway device 300 checks the received AARQ, and may then assign a new session ID through which the current security session can be identified.

Also, at step S112, a cipher suite and a named curve list, included in the received AARQ, may be checked.

Here, at step S112, only when the cipher suite is an encryption algorithm based on ECDHE-PSK is a suitable named curve selected from the named curve list, in which case a temporary manager public key (Manager EC PK) may be selected.

FIG. 6 shows security session information to be sent by the gateway device 300 when complete authentication is performed according to an embodiment of the present invention.

That is, at step S112, when complete authentication is performed, the gateway 300 may send an AARE including the security session information illustrated in FIG. 6 to the health device 200, and the health device 200 may receive the AARE to which a session ID is assigned from the gateway device 300.

Here, at step S112, when simplified authentication is performed, the health device 200 may receive an AARE including a manager_{—} finished message from the gateway device 300.

Here, at step S112, if the gateway device 300 stores the security session information that can be identified using the session ID included in the AARQ sent from the health device 200, the gateway device 300 may assign the same session ID to the AARE.

Here, at step S112, if the gateway device 300 does not store security session information that can be identified using the session ID included in the AARQ sent from the health device 200, or if the session ID expires and thus becomes invalid, a new session ID is generated, and the authentication process may be changed to complete authentication.

Also, at step S112, when simplified authentication is performed, the gateway device 300 may include the cipher suite and named curve that were used for the existing security session in the AARE.

Also, at step S112, a manager_finished message is generated with reference to information that was used for the existing security session, and the manager_finished message may be included in the AARE.

A detailed description of the generation of a ‘finished’ message will be made in the description of step S113.

FIG. 7 shows security session information to be sent by the gateway device 300 when simplified authentication is performed according to an embodiment of the present invention.

That is, at step S112, when simplified authentication is performed, the gateway device 300 may send an RARE including the security session information illustrated in FIG. 7 to the health device 200, and the health device 200 may receive the AARE in which a manager finished message is included from the gateway device 300.

Also, at step S110, an AARQ in which an agent_finished message is included n ay be sent at step S113.

Referring to FIG. 8, at step S113, first_a premaster secret n ay be generated at step S113a.

Here, at step S113A, the cipher suite and named curve included in the received AARE may be checked.

Here, at step S113A, only when the cipher suite is an encryption algorithm based on ECDHE-PSK may a temporary agent public key (Agent EC PK) be selected based on the named curve.

Here, at step S113A, an ECDHE key that is exchanged using the ECDHE key-exchange protocol based on the temporary agent public key and a temporary manager public key may be obtained.

Also, at step S113A, a premaster secret may be generated based on any one of a PSK and a PSK±ECDHE key.

Here, the premaster secret may be configured with an octet string having a length that is equal to the sum of the length of other_secret and the length of the PSK.

Premaster secret=M+other_secret+N+PSK (1)

where ‘+’ may be an operator for concatenating byte strings on the two sides.

The premaster secret is generated using the other_secret having the length of M bytes and the PSK having the length of N bytes, and the total length of the premaster secret may be (4+M+N) bytes.

Here, at step S113A, if authentication and key exchange based on a PSK encryption algorithm are performed, the premaster secret may be generated based on the PSK. Also, if authentication and key exchange based on ECDHE-PSK encryption algorithm are performed, the premaster secret may be generated based on the PSK and the ECDHE key.

In the cipher suites based on a PSK (that is, PSK_WITH_NULL_SHA, PSK_WITH_AES_128_CBC_SHA, PSK_WITH_NULL_SHA256, and PSK_WITH_AES_256_CBC_SHA256), the other secret may be a string with N bytes of 0×00 (where, N is the length of the PSK).

In the cipher suites based on ECDHE-PSK (that ECDHE_PSK_WITH_NULL_SHA256 and ECDHE_PSK_WITH_AES_256_CBC_SHA256), the other secret may be a value configured with an octet string that represents the exchanged coordinate value of a point on the elliptic curve after ECDHE key exchange using ECKAS-DH1, defined in the IEEE P1363-2000 standard, is performed.

Here, the coordinate value of the point may be an X-coordinate value thereof.

Here, the octet string may be a result of FE20SP operation (refer to section 5.5.4 of IEEE 1363-2000), and because a result having a fixed length is output when a field is given, even if the octet string starts with ‘0×00’, this may not be omitted. Here, the length of the octet string becomes M, and the octet string may correspond to the other_secret.

In other words, when an encryption algorithm based on ECDHE-PSK is used, the other_secret may have a length that is equal to the length of the octet string corresponding to the coordinate value of a point on the elliptic curve.

Also, at step S113, a master secret may be generated at step S113B.

Here, at step S113B, the master secret may be generated by applying the generated premaster secret to a Pseudo Random Function (PRF).

The master secret is a value required to be maintained along with the session ID in the security session, and may be reused when simplified authentication is performed.

Unlike the premaster secret having a variable length, the master secret may have a total length of 48 bytes.

master secret=PRF (premaster secret, “master secret”, Agent Random+Gateway Random) [0.47] (2)

where ‘+’ may be an operator for concatenating byte strings on the two sides.

Also, ‘[0.47]’ in Equation (2) may indicate that the PRF outputs a result having a length of 48 bytes.

The PRF in Equation (2) may correspond to the following Equation (3), which is defined in TES version 1.2.

PRF (secret, label, seed)=P_<hash>(secret, label+seed) (3)

where ‘+’ may be an operator for concatenating byte strings on the two sides.

In Equation (3), ‘label’ may be an ASCII string, and the length of the string and a null character may not be included therein. For example, “slithy tones” may be processed as “73 6C 69 74 68 79 20 74 6F 76 65 73”.

PRF (secret, label, seed)=P_MD5 (S1, label+seed)×or P_SHA-1 (S2, label+seed) (4)

where ‘+’ may be an operator for concatenating byte strings on the two sides.

Here, if the SHA-1 encryption algorithm is used in the cipher suite (that is, if the cipher suite is PSK_WITH_NULL_SHA or PSK_WITH_AES_128_CBC_SHA), Equation (4) may be used.

In Equation (4), P MD5 and P SHA-1 may correspond to those defined in TLS version 1.0.

In Equation (4), S1 and S2 may be acquired by dividing ‘secret’ into halves.

For example, if the length of ‘secret’ is an odd number, the length of S1 and S2 may be a value acquired by dividing the length of ‘secret’ by 2 and rounding off the result of division, and in this case, the last byte of S1 and the first byte of S2 may have the same value.

PRF (secret, label, seed)=P_SHA-256 (secret, label+seed) (5)

where ‘+’ may be an operator for concatenating byte strings on the two sides.

Here, if the SHA-256 encryption algorithm is used in the cipher suite (that is, if the cipher suite is PSK_WITH_NULL_SHA, PSK_WITH_AES_128_CBC_SHA, PSK_WITH_NULL_SHA_256, or PSK_WITH_AES_256_CBC_SHA256), Equation (5) may be used.

In Equation (5), P_SHA-256 may correspond to that defined in TLS version 1.2.

Also, at step S113, a ‘finished’ message may be generated at step S113C.

That is, at step S113C, a ‘finished’ message may be generated by applying the generated master secret and security session information to a PRF.

Finished=PRF (master secret, finished_label, Hash (handshake messages) [0.11] (6)

In Equation (6), as to what [0.11] means, a ‘Finished’ message may have a length of 12 bytes. Here, ‘finished_label’ may become “agent finished” in the case of an agent_finished message sent by the health device 200, or may become “manger finished” in the case of a manager finished message sent by the gateway device 300. Also, ‘handshake messages’ may be a message in which all of the messages (Version, Random, and the like), sent and received just before sending a ‘finished’ message, are connected, and may include only the values of the attributes of the security session information. Also, the ‘Hash ( )’ function may be a hash function determined depending on the cipher suite that is used.

Also, at step S113, a session key may be generated at step S113D.

That is, at step S113d, the health device 200 may generate a key block, in which a Message Authentication Code (MAC) secret and an encryption key are separate from each other, by applying the generated master secret to the PRF.

Key Block=PRF (master secret, “key expansion”, Manager Random+Agent Random) (7)

where ‘+’ may be an operator for concatenating byte strings on the two sides.

Here, the length of the key block may be determined depending on the cipher suite. The generated key block may be divided into an agent MAC secret, a manager MAC secret, an agent encryption key, and a manager encryption key.

The agent MAC secret may be a key for generating and verifying the MAC of an application message sent by' the health device 200.

The manager MAC secret may be a key for generating and verifying the MAC of an application message sent by the gateway device 300.

The agent encryption key may be a key for encrypting and decrypting an application message sent by the health device 200.

The manager encryption key may be a key for encrypting and decrypting an application message sent by the gateway device 300.

Here, the keys separated from the generated key block may correspond to a session key.

FIG. 9 shows information included in the key block that is generated from the master secret according to an embodiment of the present invention.

Particularly, as shown in FIG. 9, the length of a MAC secret and the length of an encryption key may vary depending on the cipher suite.

Also, at step S113, an AARQ in which an agent finished message is included may be sent at step S113E.

That is, at step S113E, the health device 200 may send the gateway device 300 an AARQ m which a temporary agent public key (Agent EC PK), the PSK identity of the health device 200, and the generated ‘finished’ message are included.

FIG. 10 shows information about an AARQ including an agent_finished, which is to be sent by the health device (agent), according to an embodiment of the present invention.

The information about an AARQ including an agent_finished message may be configured to include ‘Agent EC PK’, which is a temporary agent public key, ‘PSK Identity’, and ‘Finished’, which is an agent_finished message.

Here, ‘PSK Identity’ may be information for identifying the health device 200 that is currently performing authentication and key exchange.

Also, at step S110, an AARE in which a manager finished message is included may be received at step S114.

Referring to FIG. 11, at step S114, first, the gateway device 300 may generate a master secret at step S114A.

Here, at step S114A, the gateway device 300 may receive an AARQ in which an agent_finished message is included.

Here, at step S114A, the gateway device 300 may refer to an authentication DB using the PSK identity included in the received AARQ, the PSK identity corresponding to that illustrated in FIG. 10.

Here, at step S114A, using the PSK identity, the gateway device 300 may receive a PSK or an ECDHE key from the authentication DB, depending on the cipher suite of the health device 200.

Here, at step S114A, according to the process of generating a master secret, which was described at step S113B, the gateway device 300 may generate a master secret based on the PSK or ECDHE key of the health device 200, which is received from the authentication DB.

Also, at step S114, a manager_finished message may be generated at step S114B.

That is, at step S114b, the gateway device 300 may generate a manager finished message using the generated master secret.

Here, at step S114B, the gateway device 300 may generate the manager finished message using the master secret, generated at step S114A, according to the process of generating a ‘finished’ message, which was described at step S113C.

Also, at step S114, the generated manager_finished message may be compared with the received agent_finished message at step S114C.

Here, when it is determined at step S114C that the received agent_finished message is identical to the generated manager_finished message, an AARE including the manager_finished message may be generated.

Here, when it is determined at step S114C that the received agent_finished message is not identical to the generated manager_finished message, the process may be restarted from any one of the above-described steps, or the authentication and key exchange process may be terminated.

Also, at step S114, the AARE including the manager finished message may be sent at step S114D.

Here, at step S114D, the gateway device 300 may send the AARE including the manager finished message, generated by the gateway device 300, to the health device 200.

FIG. 12 shows information about an AARE including a manager finished message, sent by the gateway device 300, according to an embodiment of the present invention.

As illustrated in FIG. 12, because the agent_finished message received by the gateway device 300 is identical to the manager_finished message generated by the gateway device 300, the AARE includes only the manager_finished message.

That is, at step S114D, the health device 200 may receive the AARE including the manager_finished message generated by the gateway device 300.

Also, at step S110, whether authentication and key exchange have succeeded may be determined at step S115.

Here, at step S115, the agent_finished message generated by the health device 200 at step Si 13C may be compared with the manager_{—} finished message received from the gateway device 300.

Here, at step S115, if the generated agent_finished message is identical to the received manager_finished message it may be determined that authentication and key exchange have succeeded.

When it is determined at step S115 that authentication and key exchange have succeeded, it may be confirmed that mutual authentication between the health device 200 and the gateway device 300 has succeeded, and that they possess the same session key.

That is, after the success in authentication and key exchange, the health device 200 and the gateway device 300 may share the same agent MAC secret, the same manager MAC secret, the same agent encryption key, and the same manager encryption key.

Here, at step S115, if the generated agent_finished message is not identical to the received manager finished message, the process may be restarted from any one of the above-described steps, or the authentication and key exchange process may be terminated.

Also, at step S113, if simplified authentication is performed, the health device 200 may check the received AARE in which a ‘finished’ message is included.

Here, at step S113, the session ID of the received AARE is compared with the stored session ID, and if the two session IDs are found to be identical to each other as the result of the comparison, the master secret of the existing security session is searched for, and an agent finished message may be generated using the master secret.

Here, at step S113, if it is determined that the session ID of the received AARE is not identical to the stored session ID, the authentication process is changed to complete authentication, and then authentication and key exchange may be performed.

Here, at step S113, when it is determined that the generated agent_finished message is identical to the received manager_finished message as a result of a comparison, the health device 200 may send an AARQ including the agent_finished message to the gateway device 300.

Here, information about the AARQ including the agent_finished message includes only the agent_finished message, as shown in FIG. 12.

Here, at step S113, when it is determined that the generated agent finished message is not identical to the received manager_finished message, the authentication process may be changed to complete authentication, the process may be restarted from any one of the above-described steps, or the authentication and key exchange process may be terminated.

Also, at step 4115, if simplified authentication is performed, the gateway device 300 receives the AARQ including the agent_finished message, and may compare the agent_finished message included in the received AARQ with the generated manager_finished message.

Here, at step S115, if the received agent_finished message is identical to the generated manager_finished message, it may be determined that authentication and key exchange have succeeded.

When it is determined at step S115 that authentication and key exchange have succeeded, it may be confirmed that mutual authentication between the health device 200 and the gateway device 300 has succeeded, and that they possess the same session key.

That is, after the success in authentication and key exchange, the health device 200 and the gateway device 300 may share the same agent MAC secret, the same manager MAC secret, the same agent encryption key, and the same manager encryption key.

Here, at step S115, if the received agent_finished message is not identical to the generated manager_finished message, the process may be restarted from any one of the above-described steps, or the authentication and key exchange process may be terminated.

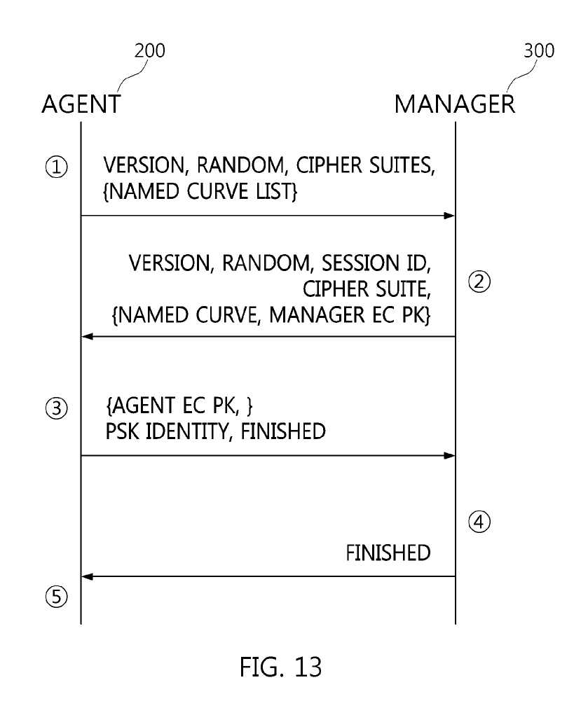

FIG. 13 is a sequence diagram that shows an authentication and key exchange process when complete authentication is performed according to an embodiment of the present invention.

Referring to FIG. 13, when complete authentication is performed, the health device 200 (agent) includes ‘Version’, ‘Random’, ‘Cipher Suites’, and ‘Named Curve List’ in an AARQ and send the AARQ to the gateway device 300 (manager) (\textcircled{1} in FIG. 13).

Here, ‘Named Curve List’ may be included in the AARQ only when ‘Cipher Suites’ corresponds to an ECDHE-PSK encryption algorithm.

Also, the gateway device 300 receives the AARQ, includes ‘Version’, ‘Random’, ‘Session ID’, ‘Cipher Suite’, ‘Named Curve’ and ‘Manager EC PK’ in an AARE, and sends the AARE to the health device 200 (\textcircled{2} in FIG. 13).

Here, ‘Named Curve’ and ‘Manager EC PK’ may be included in the AARE only when ‘Cipher Suite’ corresponds to an ECDHE-PSK encryption algorithm.

Also, the health device 200 receives the AARE, includes ‘Agent EC PK’, ‘PSK Identity’, and ‘Finished’ (which is an agent finished message) in an AARQ, and sends the AARQ to the gateway device 300 (\textcircled{3} in FIG. 13).

Here, ‘Agent EC PK’ may be included in the AARQ only when ‘Cipher Suite’ corresponds to an ECDHE-PSK encryption algorithm.

Also, the gateway device 300 compares the received agent_finished message with a manager_finished message, generated based on the received ‘PSK Identity’, and may send an AARE including ‘Finished’, which corresponds to the manager_finished message, to the health device 200 (\textcircled{4} in FIG. 13) when it is determined that the manager_finished message is identical to the agent_finished message as the result of the comparison.

Also, the health device 200 may determine whether authentication and key exchange have succeeded by comparing the: received manager_finished message with the generated agent_finished message (\textcircled{5} in FIG. 13).

That is, as illustrated in FIG. 13, when complete authentication is performed, the authentication and key exchange process may be configured with four iterations of transmission and reception of messages (AARQs and AAREs).

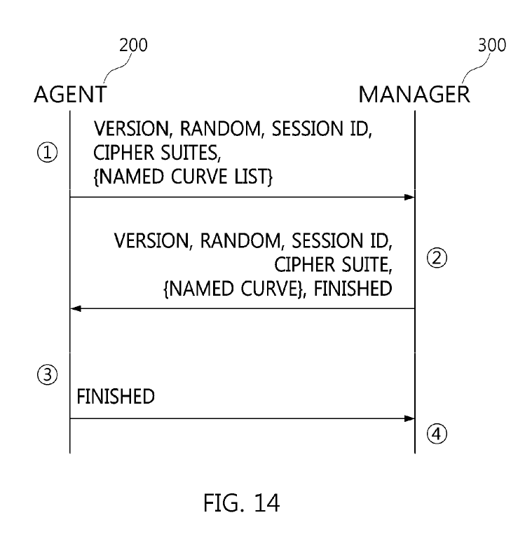

FIG. 14 is a sequence diagram that shows an authentication and key exchange process when simplified authentication is performed according to an embodiment of the present invention.

Referring to FIG. 14, when simplified authentication is performed, the health device 200 (agent) includes ‘Version’, ‘Random’, ‘Session ID’, ‘Cipher Suites’, and ‘Named Curve List’ in an AARQ and sends the AARQ to the gateway device 300 (manager) (\textcircled{1} in FIG. 14).

Here, ‘Named Curve List’ may be included in the AARQ only When ‘Cipher Suites’ corresponds to an ECDHE-PSK encryption algorithm.

Also, the gateway device 300 receives the AARQ, includes ‘Version’, ‘Random’, ‘Session ID’, ‘Cipher Suite’, ‘Named Curve’, and ‘Finished’ (which is a manager finished message) in an AARE, and sends the AARE to the health device 200 (\textcircled{2} in FIG. 14).

Here, ‘Named Curve’ may be included in the AARE only When ‘Cipher Suite’ corresponds to an ECDHE-PSK encryption algorithm.

Also, the health device 200 receives the AARE and compares the received manager_finished message with the generated agent_finished Message. When it is determined that the received manager_finished message is identical to the generated agent_finished message, the health device 200 may send an AARQ including ‘Finished’ (which corresponds to the agent finished message) to the gateway device 300 (\textcircled{3} in FIG. 14).

Also, the gateway device 300 may determine whether authentication and key exchange have succeeded by comparing the received agent_finished message with the generated manager finished message (\textcircled{4} in FIG. 14).

That is, as illustrated in FIG. 14, when simplified authentication is performed, the authentication arid key exchange process may be configured with three iterations of transmission and reception of messages (AARQs and an AARE).

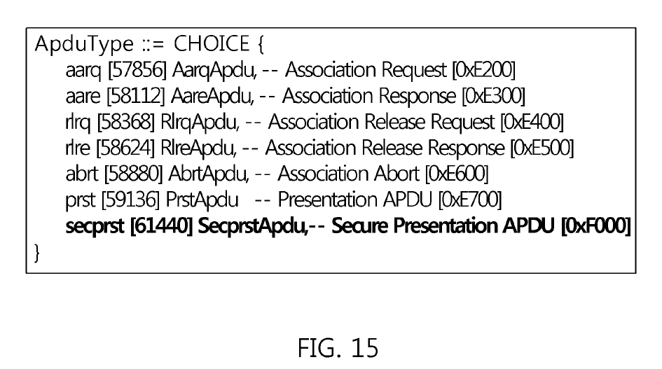

FIGS. 15 to 18 are views that show an AARQ including security session information and an AARE including security session information according to an embodiment of the present invention.

In order to secure the IEEE 11073-20601 protocol, the following two factors may be considered. First, the association process defined in the IEEE 11073-20601 is configured such that an AARQ and an AARE are sent and received once, but complete authentication and simplified authentication require message exchange four and three times, respectively. Second, it is necessary to modify the AARQ and AARE defined in the IEEE 11073-20601 in order to enable the AARQ and the AARE to contain information that must be sent when a complete authentication process, a simplified authentication process, or a message protection protocol is performed.

That is, Abstract Syntax Notation One (ASN.1) for the AARQ and AARE to be used for the authentication and key exchange process at step S110 may be newly defined in the present invention.

The IEEE 11073-20601 Annex A defines ASN.1 of messages (AARQ and AARE), sent and received in a communication process, and in order to secure a message, ‘secprst’ (Secure PRST) may be additionally defined in a message frame of the highest level.

Referring to FIG. 15, Secure Presentation (secprst) is defined in an Application Protocol Data Unit Type (ApduType) of AARQ and AARE.

AARQ may be defined as AarqApdu' in the IEEE 11073-20601 protocol, and security session information necessary for authentication and key exchange may be added to ‘AarqApdu’.

In ‘AarqApdu’, ‘DataProtoList’, which is a structure within AarqApdu, may correspond to a list of ‘DataProto's, and ‘DataProto’ may be configured with data-proto-id’ and ‘data-proto-info’.

Here, if the value of ‘data-proto-id’ is defined as “data-proto-id-20601”, ‘data-proto-info’ may take the structure ‘PhdAssociationInformation’.

That is, AARQ contains the structure ‘PhdAssociationinformation’, and security session information for association, authentication, and key exchange may be exchanged with the gateway device 300 by being included in the structure PhdAssociationInformation'.

Next, AARE may be defined as ‘AareApdu’ in the IEEE 11073-20601 protocol, and security session information necessary for authentication and key exchange may be added to ‘AareApdu’.

In ‘AareApdu’, ‘DataProto’, selected from ‘DataProtoList’ included in the received ‘AarqApdu’, may be present.

Here, if the value of ‘data-proto-id’ is defined as “data-proto-id-20601”, ‘data-proto-info’ may take the structure ‘PhdAssociationinformation’.

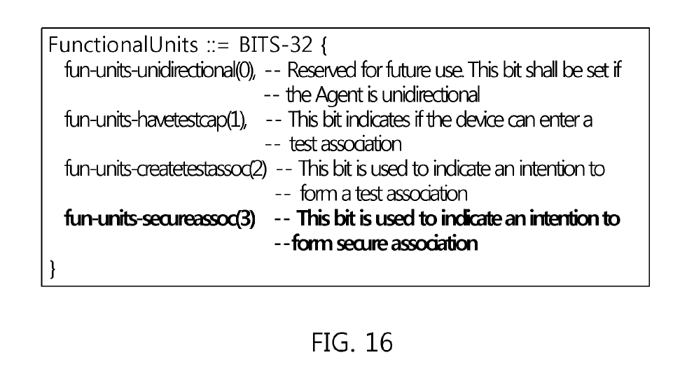

Referring to FIG. 16, it is confirmed that a message for security protocol (secureassoc) is defined in ‘FunctionalUnits’ of ‘PhdAssociationInformation’ for a secured application message.

Security session information for authentication and key exchange may be added to ‘option-list’ of ‘PhdAssociationInformation’ of AARQ and AARE. Here, in order to define the structure to be added to ‘option-list’ as ‘AVA-Type’, a structure may contain ‘attribute-id’ for the identifier of an attribute and ‘attribute-value’ for the value of the attribute.

The first sent AARQ may include the following attributes:

Version

Random

Session ID (only when simplified authentication is performed)

Cipher Suites

Named Curve List (when cipher suites based on ECDHE are included in association)

The second AARQ may include the following attributes:

Agent EC PK (when a cipher suite based on ECDHE is used for key exchange)

PSK Identity

Finished

When two or more ‘DataProto's are included in ‘DataProtoList ’ of ‘AarqApdu’, each ‘DataProto’ may include the same ‘option-list’.

The first sent AARE may include the following attributes:

Version

Random

Session ID

Cipher Suite

Named Curve (when key exchange is performed using a cipher suite based on ECDHE)

Manager EC PK (when key exchange is performed using a cipher suite based on ECDHE and when complete authentication is performed)

Finished (when simplified authentication is performed)

The second AARE may include the following attribute:

Finished (included when complete authentication is performed, but not included when simplified authentication is performed)

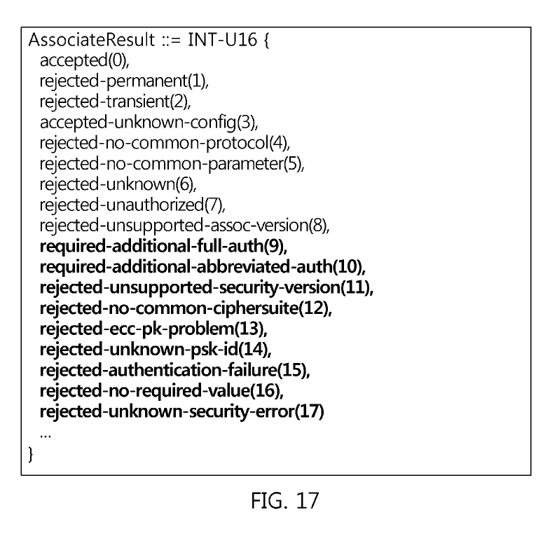

FIG. 17 shows ‘AssociateResult’ for representing the result of association according to an embodiment of the present invention.

Here, when an AARE containing a result that includes ‘reject’, defined in ‘AssociateResult’, is returned, ‘PhdAssociationInformation’ may not be included in the AARE, and ‘option-list’, which contains authentication-related information, may also not be included therein.

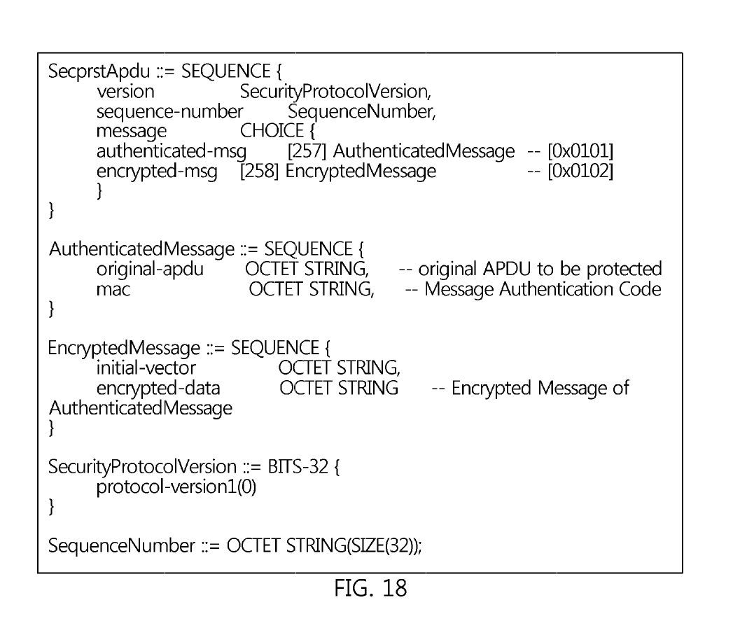

FIG. 18 shows Secure PRST message defined as ASN.1 according to an embodiment of the present invention.

Depending on the cipher suite, ‘message’ in ‘SecprstApdu’ may take ‘authenticated-msb’ or ‘encrypted-msg’.

That is, in the case of a cipher suite that supports only MAC (that is, PSK_WITH_NULL_SHA, PSK_WITH_NULL_SHA256, or ECDHE_PSK_WITH_NULL_SHA256), ‘authenticated-msg,’ may be taken, and in the case of a cipher suite that supports encryption (that is, PSK_WITH_AES_128_CBC_SHA, PSK_WITH_AES_256_CBC_SHA256, or ECDHE_PSK_WITH_AES_256_CBC_SHA256), ‘encrypted-msg’ may be taken.

Here, a message that does not correspond to a cipher suite may be ignored.

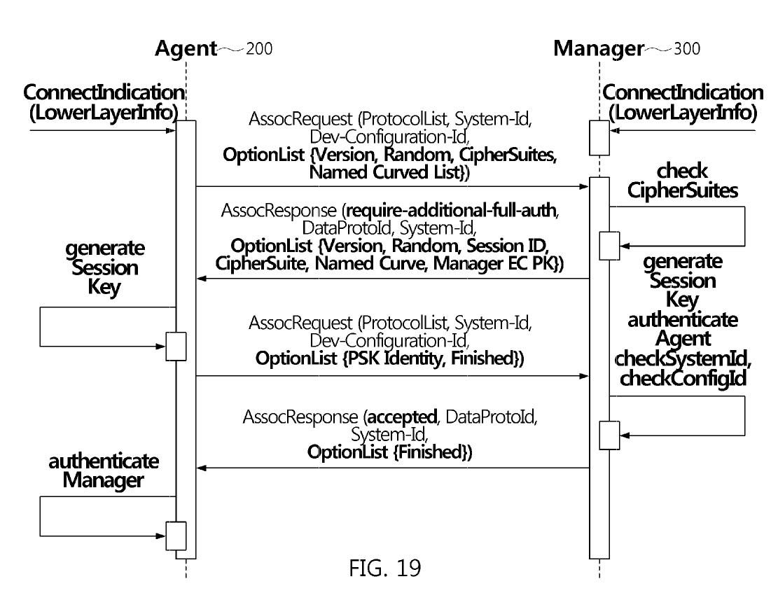

FIG. 19 is a sequence diagram that shows an authentication and key exchange process using an AARQ and an AARE according to an embodiment of the present invention.

Referring to FIG. 19, the health device 200 (agent) and the gateway device 300 (manager) according to an embodiment of the present invention perform authentication and key exchange according to a complete authentication process at step 110.

Here, as described above with reference to FIGS. 15 to 18, authentication and key exchange are performed by including security session information for authentication and key exchange in ‘option-list’ of AARQ and AARE.

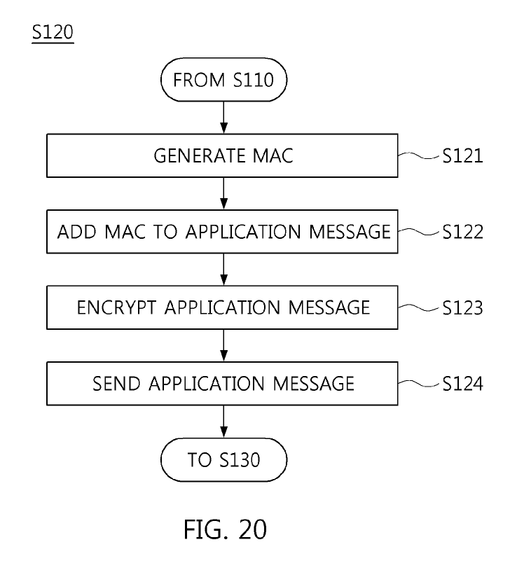

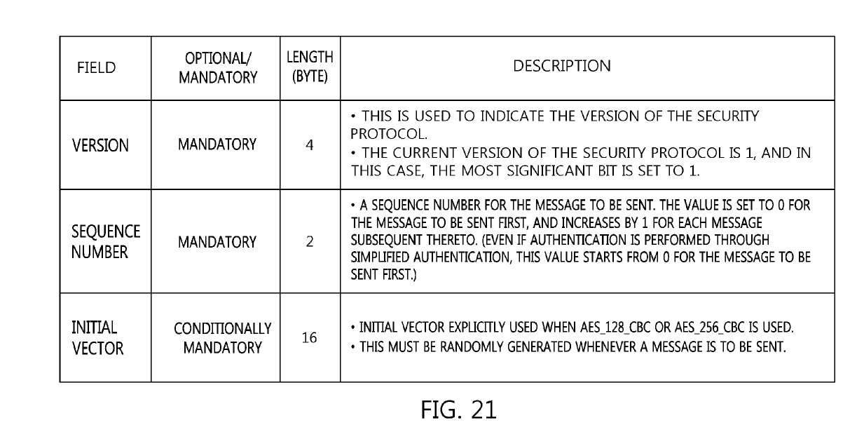

FIG. 20 is a flowchart that specifically shows an example of the step of sending an application message, illustrated in FIG. 1. FIG. 21 is a table that shows information that is necessary for securing an application message according to an embodiment of the present invention.

The step of sending an application message (S120) illustrated in FIG. 20 may be a step in which, after mutual authentication and key exchange at step S110 have succeeded, an application message is secured and sent based on the mutually agreed security session information. A message security protocol used at step S120 :may provide a function for verifying whether a message sent from a sender arrives without being falsified and a function for encrypting a message such that the content of the message is prevented from being viewed by a third party.

Securing an application message may support only Message Authentication Code (MAC) depending on the selected cipher suite (when the cipher suite is PSK_WITH_NULL_SHA, PSK_WITH_NULL_SHA256, or ECDHE_PSK_WITH_NULL_SHA256), or may support both MAC and encryption (when the cipher suite is PSK_WITH_AES_128_CBC_SHA, PSK_WITH_AES_256_CBC_SHA256, or ECDHE_PSK_WITH_AES_256_CBC_SHA256).

Referring to FIG. 20, at step S120, first, Message Authentication Code (MAC) may be generated at step S121.

That is, at step S121, MAC may be generated using a MAC secret.

HMAC_hash (MAC_secret, Sequence Number+Version+Original Message Length (2 bytes)+Original Message) (8)

where ‘+’ may be an operator for concatenating byte strings on the two sides.

Here, at step S121, MAC may be generated using a Hash-based Message Authentication Code (HMAC) function, as shown in Equation (8).

Here, at step S121, as shown in Equation (8), MAC may be generated using a MAC secret (an agent MAC secret or a manager MAC secret) based on an original message, version information, and a sequence number.

Here, the sequence number may be calculated by adding 1 to the stored sequence number, and may be immediately updated to the newly calculated value.

Here, HMAC_hash in Equation (8) may follow the definition of 2104,

Also, at step S120, the MAC may be added to the original message at step S122.

That is, at step 8122, the generated MAC may be added to the original message, and padding may be additionally added thereto if necessary.

Here, at step S122, when the length of the original message to which the MAC is added is not a multiple of a block length of the defined encryption algorithm, padding may be added to the original message to which the MAC is added.

Here, padding may be information to be added in order to knee a length to become a multiple of a block size when the sum of the length of the original message and the length of the MAC is not a multiple of the block size (16 or 32 bytes) of the encryption algorithm that is used.

Here, the length of the padding may be up to 256 bytes, and padding having a length longer than the required minimum length may be added.

For example, assume that the sum of the length of the original message and the length of MAC is 135 bytes in an environment in which AES-256 is used as an encryption algorithm. In this ease, in order to make the length (that is, 135 bytes) a multiple of 32 bytes, which is the block size of AES-256, a minimum of 25 byes (32×5−135) of padding is necessary.

However, if the length can become a multiple of the block size, a value greater than the required minimum value (for example, 57=25+32) may become the length of the padding, and this may hinder external attackers from predicting the total length of a packet from the aspect of security.

Padding according to an embodiment of the present invention differs from a padding rule defined in TLS version 1.2 and versions lower than that, which take into consideration backward compatibility. Here, in consideration of implementation and conformance to standards, the value of padding may be generated based on padding rules of PKCS #7 and IETF RFC 2315, as shorn below.

For example when N-byte padding is added at step S122 in order to match the block size, padding may be an octet string configured with N number of ‘N's, wherein ‘N’ is a one-byte integer. That is, if the length of padding to be added is bytes, “0×06 0×06 0×06 0×06 0×06 0×06” configured with six ‘0×06's may be added as the padding.

Here, at step S122, if 6 bytes of padding is necessary, it is possible to add 38 bytes (32+6) of padding. In this case, 38 bytes of padding, configured with a list of 0×26 (which is 38 in decimal), namely, “0×26 0×26 0×26 0×26 0×26 0×26 0×26 0×26 0×26 0×26 0×26 0×26 0×26 0×26 0×26 0×26 0×26 0×26 0×26 0×26 0×26 0×26 0×26 0×26 0×26 0×26 0×26 0×26 0×26 0×26 0×26 0×26 0×26 0×26 0×26 0×26 0×26 0×26”, may be added.

Also, at step S122, if a cipher suite does not support encryption, the process of adding padding may be skipped.

Here, referring to FIG. 18 again, ‘original-apdu’, which is the original message to be protected, may take various messages defined in ‘ApduType’ excluding ‘secprst’.

Here, a message encoded according to Medical Device Encoding Rules (MDER) defined in the IEEE 11073-20601 may be placed in ‘original-apdu’.

In ‘AuthenticatedMessage’, ‘mac’ may be a value generated by applying ‘original-apdu’, ‘version’, and ‘sequence-number’ to an HMAC function as a key for generating MAC, according to a defined hash algorithm.

Here, depending on the used hash algorithm, the length of MAC may be 20 bytes (in the case of SHA-1) or 32 bytes (in the case of SHA-256).

In the present invention, a block-based encryption algorithm may be used for encryption of a message. Accordingly, the size of a message to be encrypted must match the block Size, and When the size of the message does not match the block size, padding may be added to the message. The message to be encrypted may include three elements, that is, the original message encoded according to MDER (original-apdu), message authentication code (MAC), and padding to be used to match the block size.

The method of adding padding may be performed as described above, and the length of an octet string, included when the original message is encoded according to MDER, may be ignored. That is, padding may be generated after the actual value of MAC is added to the encoded ‘original-apdu’ (exclusive of the length thereof).

Also, at step S120, an application message may be encrypted at step. S123.

That is, at step S123, an application message may be encrypted with an encryption key and an Initial Vector (IV).

Here, at step S123, among AES-128 and AES-256, any One CBC mode encryption algorithm may be used. In the CBC mode encryption algorithm, an IV may be randomly generated and the generated IV may be used. The length of the IV may correspond to the length of a single block in the used block encryption algorithm, and may be 16 bytes in the case of AES-126 and AES-256.

Here, the IV may be randomly generated whenever an application message is sent.

Here, the encryption key may be an agent encryption key or a manager encryption key.

Here, referring to FIG. 18, the result of encryption, which is performed using an application message, an encryption key, and an IV according to an encryption algorithm defined in the cipher suite, may be included in ‘encrypted-data’ of ‘EncryptedMessage’. The IV may be included in ‘initial-vector’.

Also, step S122 may be skipped When a cipher suite does not support encryption.

Also, at step S120, an application message may be sent at step S124.

That is, at step S124, the health device 200 or the gateway device 300 may send the encrypted application message to the gateway device 300 or the health device 200.

Here, at step S124, version information, a sequence number, and the initial vector may be included in the header information of the application message to be sent.

Here, at step S124, the header information is inserted, and the encrypted application message is then sent.

FIG. 21 shows information additionally required in the message security protocol in order to protect an original message.

The information additionally required in the message security protocol includes version information, a sequence number, and an initial vector.

Here, the sequence number may be maintained separately for messages respectively sent by the health device 200 and the gateway device 300. In an environment in which the message security protocol is used, because the reliability of the transmission of a message is not guaranteed, the sequence number may be explicitly maintained. On the side of a receiver of an application message for example, the. gateway device 300 may be a receiver if a message is sent from the health device 200), if the sequence number of an application message sent by the other party is not greater than the latest sequence number maintained by the receiver, the receiver may ignore the received application message. Also, if this problem is repeated as many times as a preset value, this may be regarded as a replay attack, and the current security session may be terminated.

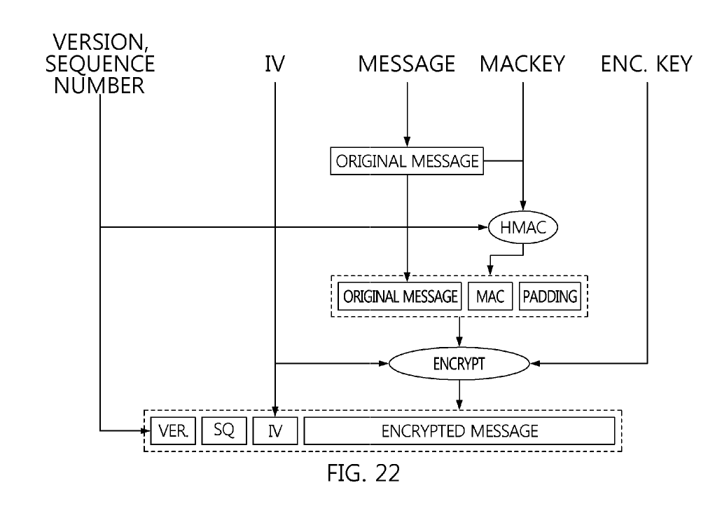

FIG. 22 is a view that shows the process of encrypting an application message according to an embodiment of the present invention.

Referring to FIG. 22, an original message is encrypted through the described processes at step S120.

In the process of encrypting an application message according to an embodiment of the present invention, Message Authentication Code (MAC) may be generated by applying an original message, a MAC secret, version information, and a sequence number to an HMAC function.

Here, in the process of encrypting an application message, the generated MAC is added to the original message, padding is additionally added thereto if necessary, and encryption may be performed.

Here, the original message to which additional information is added may he encrypted using an encryption key and an initial vector.

Finally, in the process of encrypting an application message, the version information (Ver.), the sequence number (SQ), and the initial vector (IV) are included in the header of the encrypted message.

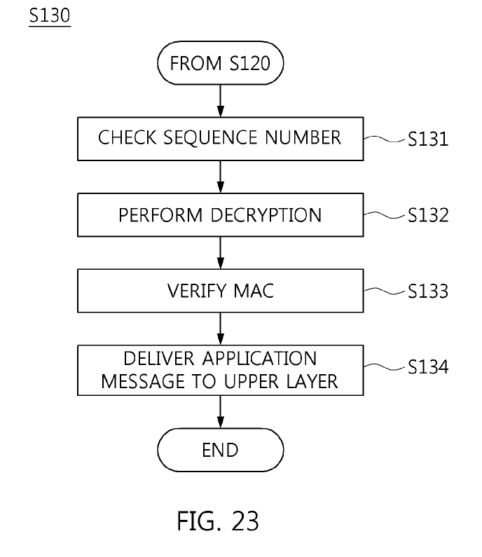

FIG. 23 is a flowchart that specifically shows an example of the step of receiving an application message, illustrated in FIG. 1.

Referring, to FIG. 23, at step S130, first, a sequence number may be checked at step S131.

That is, at step S131, the sequence number of a received application message may be checked.

Here, at step S131, version information, a sequence number, and an initial vector may be separated from the header information inserted in the received application message.

Here, at step S131, whether the received sequence number is greater than the currently maintained sequence number is determined.

Here, at step S131, if it is determined that the received sequence number is greater than the currently maintained sequence number, the current sequence number may be updated to the received sequence number.

Here, at step S131, if the received sequence number is equal to or less than the maintained sequence number, the received application message may be ignored, or error handling may be performed.

Also, at step S130, decryption may be performed at step S132.

That is, at step S132, the application message, the sequence number of which is verified, may be decrypted using the encryption key.

Here, at step S132, the received application message may be decrypted using the initial vector, which is separated from the header information, and the encryption key of the sender.

Here, if the sender is the health device 200, the encryption key may be an agent encryption key, but if the sender is the gateway device 300, the encryption key may be a manager encryption key.

Also, at step S130, whether MAC is valid r ray be checked at step S133.

That is, at step S133, whether the MAC separated from the decrypted application message is valid may be checked using a MAC secret.

Here, at step S133, if padding is present in the decrypted application message, the padding may be separated therefrom first.

Here, at step S133, when it is determined that no padding is present in the decrypted application message, or after padding is separated therefrom, MAC may be isolated.

Here, at step S133, MAC may be generated using the version information, the sequence number, and the initial vector, which are already separated from the header information at step S131.

Here, at step S133, whether the generated MAC is identical to the isolated MAC may be determined.

Also, at step S130, the application message may be delivered to the upper layer at step S134.

That is, at step S134, when verification succeeds because it is determined that the generated MAC is identical to the isolated MAC, the application message may be delivered to the upper layer of a state machine.

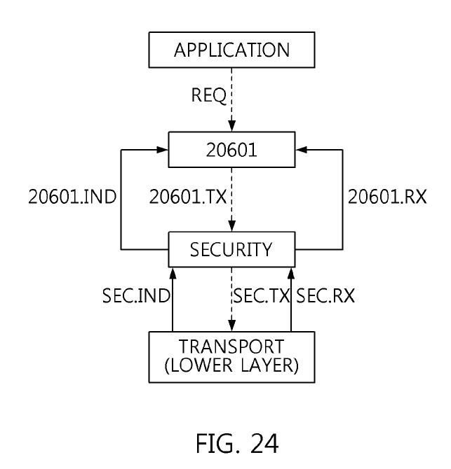

FIG. 24 is a block diagram that shows a state machine according to an embodiment of the present invention.

Referring to FIG. 24, a State machine according to an embodiment of the present invention includes an application layer; which is the highest layer, a 20601 layer, a security layer and a transport layer, which is the lowest layer.

In the communication model of the IEEE 11073-20601, processes such as association between a smart health device and a gateway, configuration information exchange therebetween, acquisition of MDS information by the smart health device, and the like are defined as a state machine. Here, the state machine defines states and actions (usually, generating and sending a packet) required when a certain event (for example, a request from an application layer, indication from a transport layer, a frame received via a transport layer, or the like) occurs in the current state.

Here, in section 8.4 of the IEEE 11073-20601 standard, the outline of a state machine for a communication model is stated, and the specific state table of the state machine is arranged in Appendix E.

When a security protocol according to an embodiment of the present invention is applied to the IEEE 11073-20601 protocol, the meaning and content of messages, sent and received between the health device 200 and the gateway device 300, may be changed.

That is, as described above, AARQ and AARE, in which authentication information and security session information are included, must be sent and received twice, and the method of processing the received messages must be changed from the existing method. Accordingly, states, events, and actions of a state machine according to an embodiment of the present invention may be newly defined.

In order to include security functions in a state machine, the present invention selects a model in which security functions are isolated as a separate layer.

The security layer illustrated in FIG. 24 may process ‘option-list’ in the authentication and key exchange process, and may process an application message.

Here, the state machine according to an embodiment of the present invention may send authentication information by including it in ‘option-list’ when an application requests association, and may process authentication information when the authentication information is received by being included in ‘option-list’.

Also, after authentication and key exchange have been completed, when securing and sending an application message are required, the state machine according to an embodiment of the present invention may apply a message security protocol to the application message before delivering it from the 20601 layer to the transport layer.

Also, the state machine according to an embodiment of the present invention may verify and decrypt a received encrypted application message and send it to the 20601 layer, which is the upper layer of the security layer.

According to an embodiment of the present invention, a state machine may have a transport layer (e.g. Bluetooth), which is the lowest layer, and a security layer, which is separate from the transport layer.

Accordingly, when a certain event occurs in the transport layer (for example, a connection is made or broken, or the like), the event is processed in the security layer and according to need, the same event may be triggered and delivered to the upper layer, which is the 20601 layer.

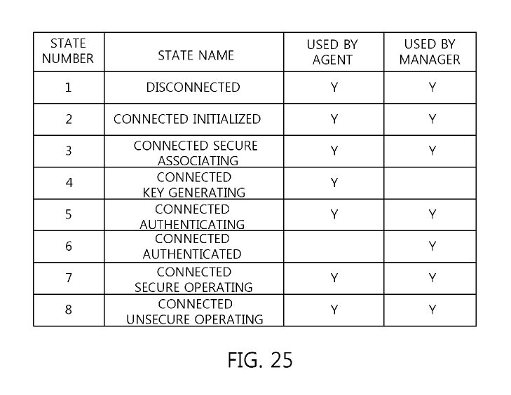

FIG. 25 is a table that shows state information used in the security layer of a state machine according to an embodiment of the present invention.

Referring to FIG. 25, the state information used in the security layer of a state machine according to an embodiment of the present invention may vary depending on whether the state information is used in the health device 200 (agent) or in the gateway device 300 (manager).

That is, in the security layer of the health device 200, state information from which the ‘Connected Authenticated’ state is excluded is used, but in the security layer of the gateway device 300, state information from which the ‘Connected Key Generating’ state is excluded is used.

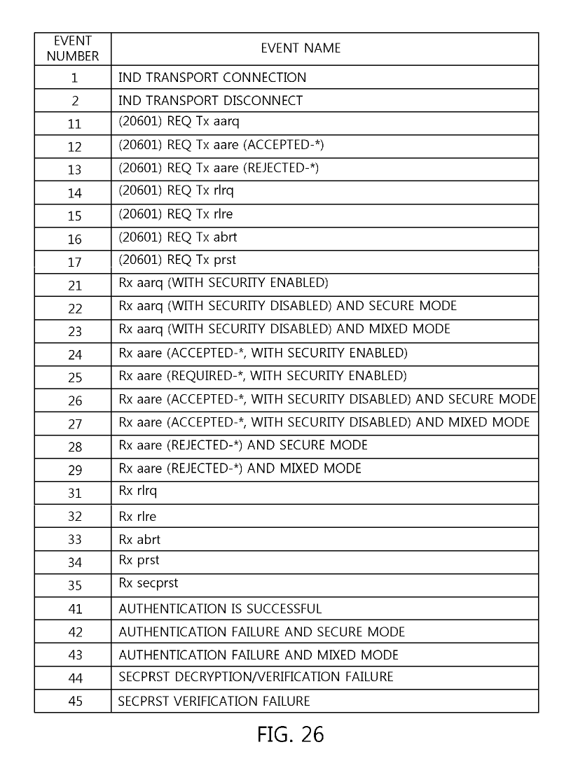

FIG. 26 is a table that shows event information used in the security layer of a state machine according to an embodiment of the present invention.

FIG. 26 shows event information used in the security layer of a state machine of a health device 200 and, gate:Way device 300 according to an embodiment of the present invention. Based On this event information, information is delivered between the layers of the state machine.

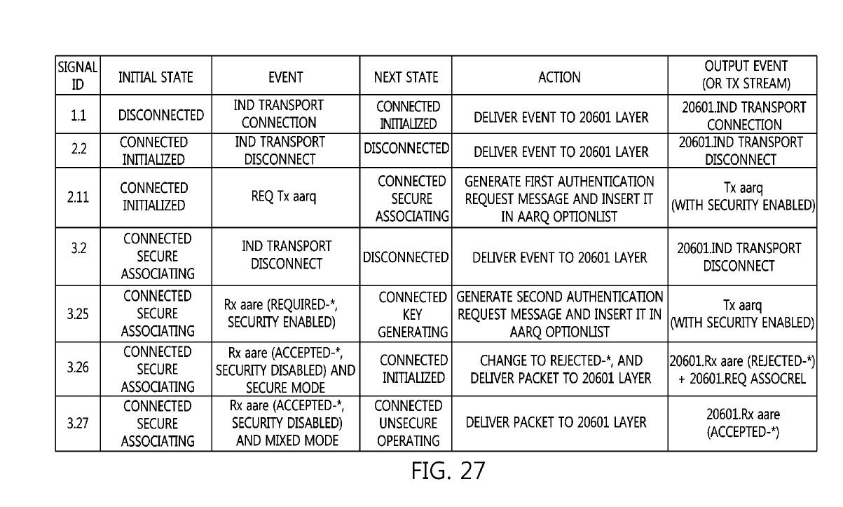

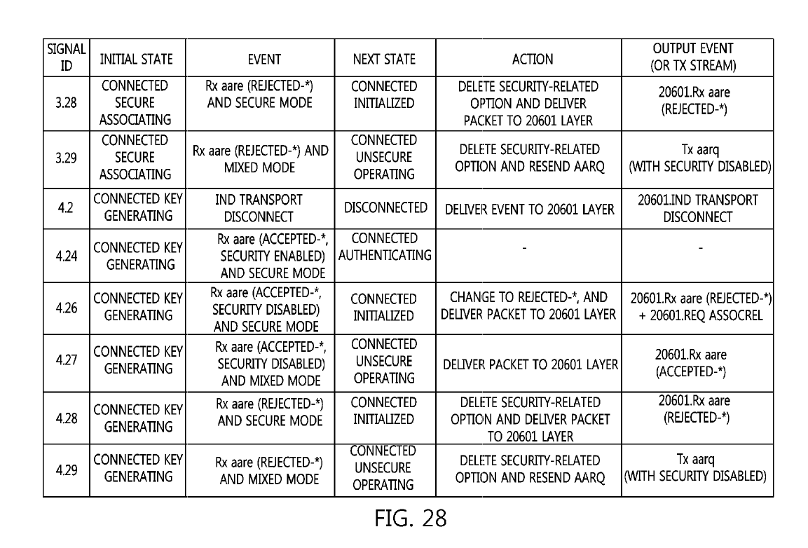

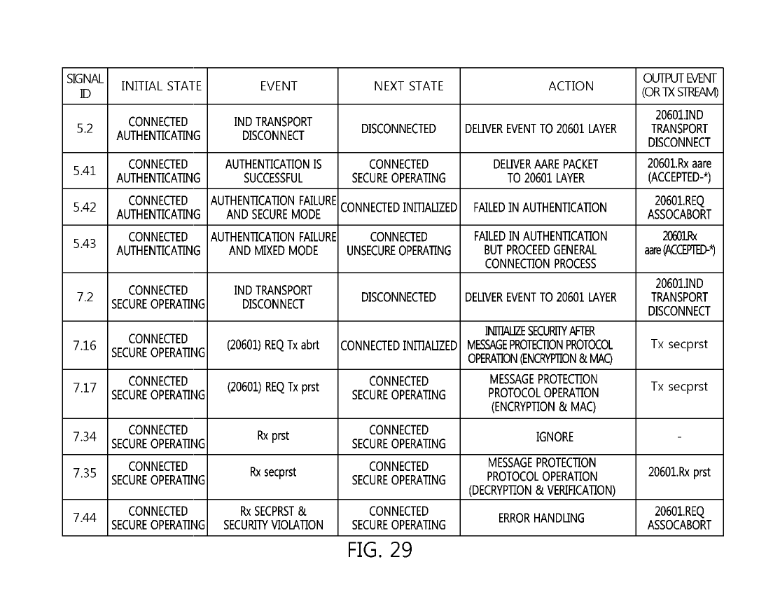

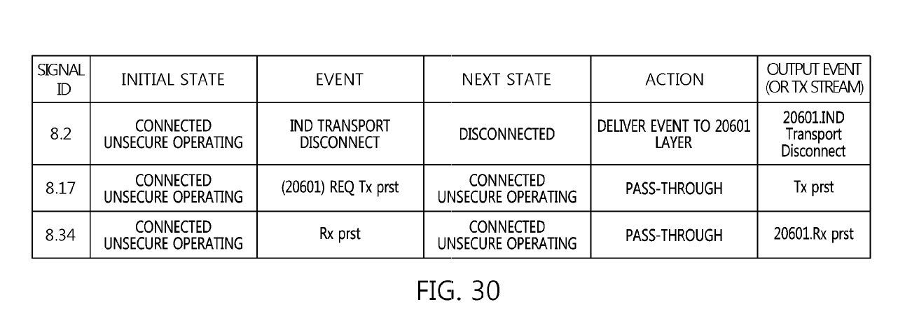

FIGS. 27 to 30 are tables that show transition information used in the security layer of a state machine of a health device.

Referring to FIGS. 27 to 30, in the security layer of the state machine of the health device 200, the type of an event, an action, an output event, and the next state are arranged for each state.

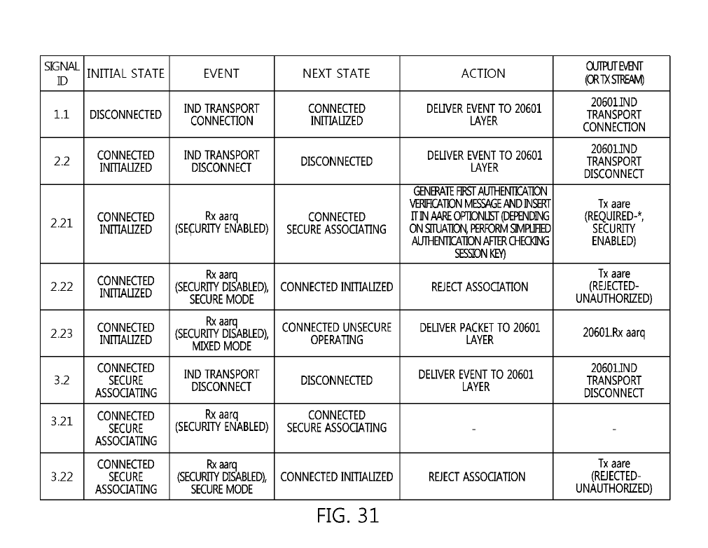

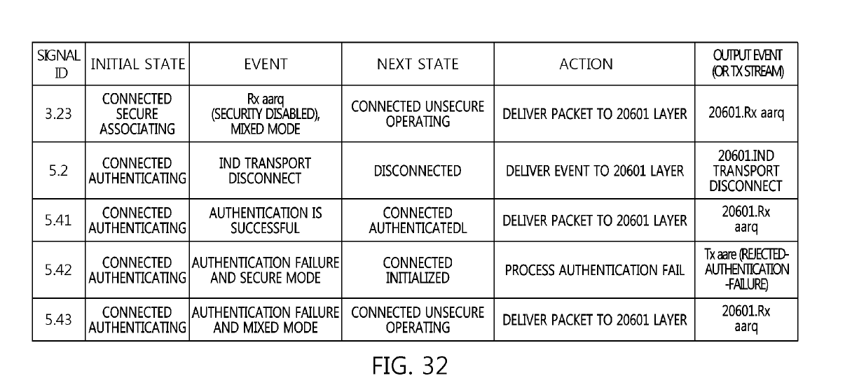

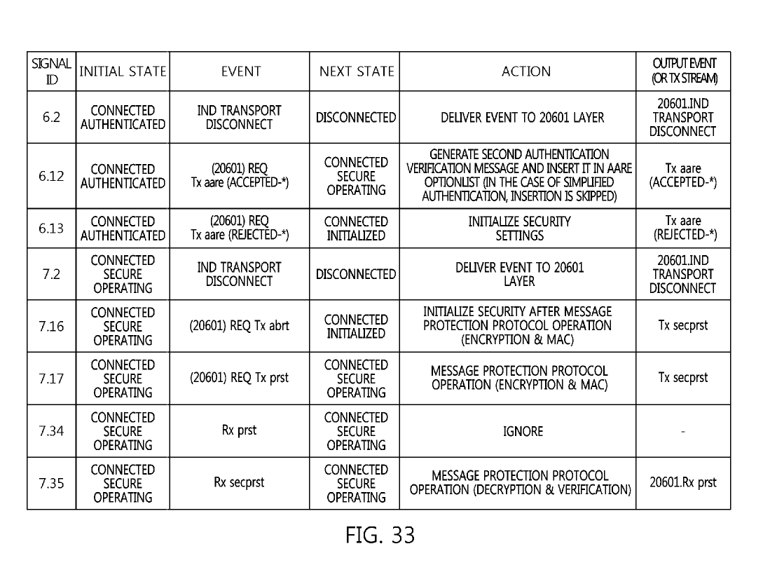

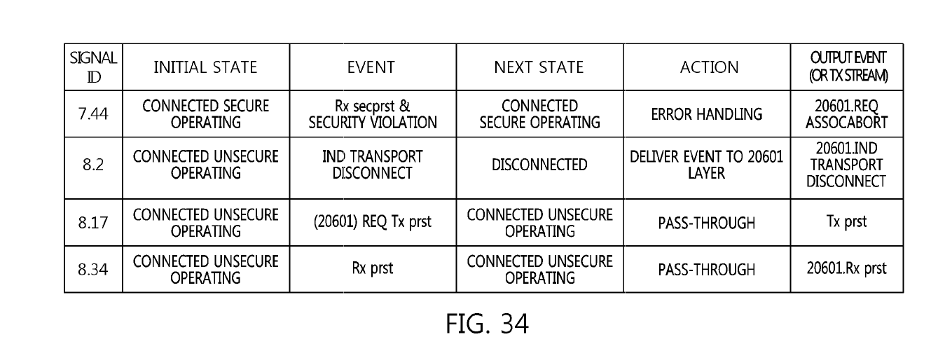

FIGS. 31 to 34 are tables that show transition information used in the security layer of a state machine of a gateway device.

Referring to FIGS. 31 to 34, in the security layer of the state machine of the gateway device 300, the type of an event, an action, an output event, and the next state are arranged for each state.

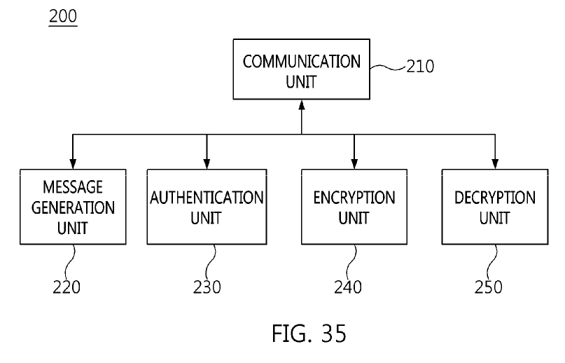

FIG. 35 is a block diagram that shows a health device according to an embodiment of the present invention.

Referring to FIG. 35, a health device 200 according to an embodiment of the present invention includes a communication unit 210, a message generation unit 220, an authentication unit 230, an encryption unit 240, and a decryption unit 250.

The communication unit 210 may send and receive a message to or from a gateway device 300.

Here, the communication unit 210 may send and receive AARQs and AAREs in an authentication and key exchange process, and may send and receive application messages in an application message transmission and reception process.

The message generation unit 220 may generate an AARQ based on security session information.

The process of generating an AARQ may correspond to the description of step S110.

The authentication unit 230 may perform authentication and key exchange based on the AARQ and au AARE received from the gateway device 300.

The authentication and key exchange process may correspond to the description of step S110.

The encryption unit 240 may secure an application message to be sent to the gateway device 300 based on the security session information.

The process of securing an application message may correspond to the description of step S120.

The decryption unit 250 may decrypt the secured application message, which is received from the gateway device 300.

The process of decrypting an application message may correspond to the description of step S130.

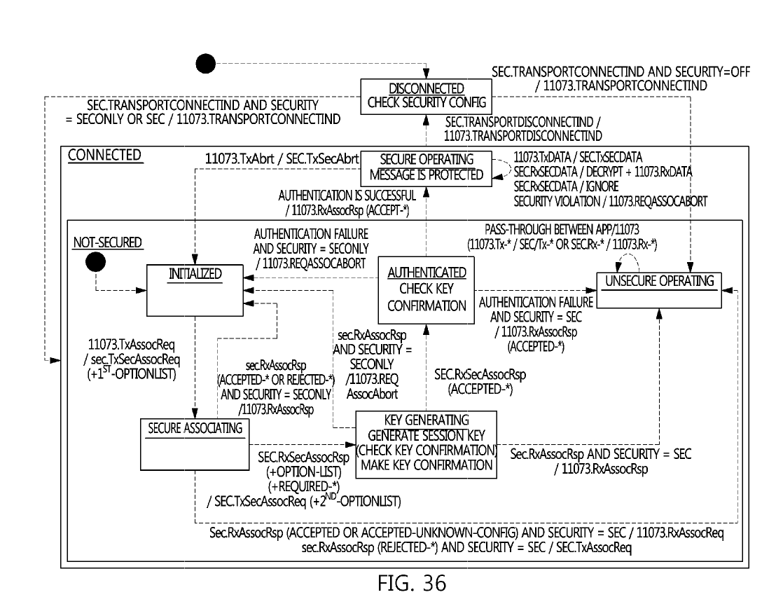

FIG. 36 is a diagram that shows a state machine of a health device according to an embodiment of the present invention.

Referring to FIG. 36, in the state machine of a health device 200 according to an embodiment of the present invention, states are largely divided into the ‘Disconnected’ state and the ‘Connected’ state.

The ‘Connected’ state may be categorized into the ‘Secure Operating’ state and the ‘Not-secured’ state.

The Not-secured' state may be categorized into the ‘Initialized’ state, the ‘Secure Associating’ state, the ‘Authenticated’ state, the ‘Key Generating’ state, and the ‘Insecure Operating’ state.

An event, an action, and an output event for each state are illustrated in FIGS. 27 to 30.

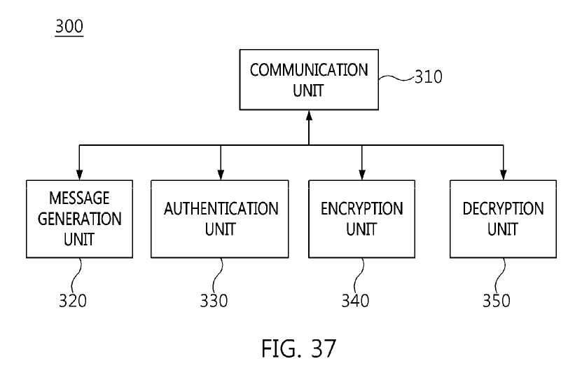

FIG. 37 is a block diagram that shows a gate device according to an embodiment of the present invention.

A gateway device 300 according to an embodiment of the present invention includes a communication unit 310, a message generation unit 320, an authentication unit 330, an encryption unit 340, and a decryption unit 350.

The communication unit 310 may send and receive a message to or from a health device 200.

Here, the communication unit 310 may send and receive AARQs and AAREs in the process of authentication and key exchange with the health device 200, and may send and receive application messages in an application message transmission and reception process.

The message generation unit 320 may generate an AARE based on security session information of the AARQ received from the health device 200.

The process of generating an AARQ may correspond to the description of step S110.

The authentication unit 330 may perform authentication and key exchange based on the AARQ received from the health device 200 and the AARE.

The authentication and key exchange process may correspond to the description of step S110.

The encryption unit 340 may secure an application message to be sent to the health device 200 based on the security session information.

The process of securing an application message may correspond to the description of step S120.

The decryption unit 350 may decrypt the secured application message, which is received from the health device 200.

The process of decrypting an application message may correspond to the description of step S130.

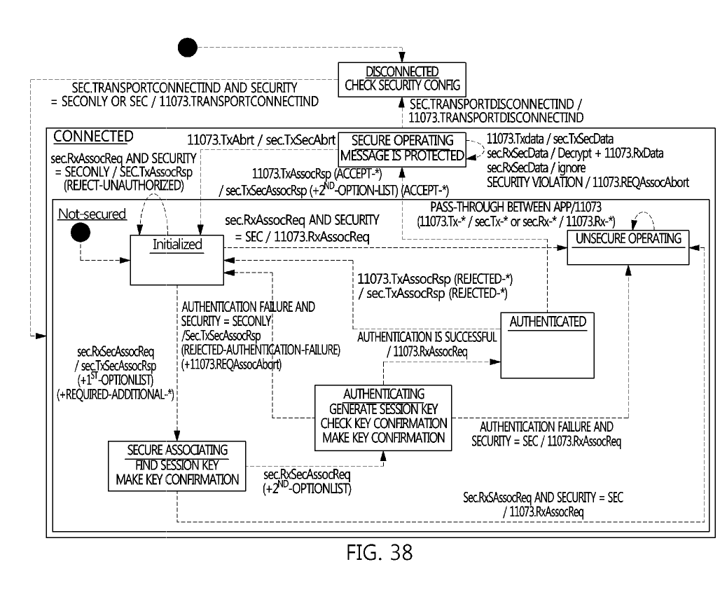

FIG. 38 is a diagram that shows a state machine of a gateway device according to an embodiment of the present invention.

In the state machine of a gateway device 300 according to an embodiment of the present invention, states are largely divided into the ‘Disconnected’ state and the ‘Connected’ state.

The ‘Connected’ state may be categorized into the ‘Secure Operating’ state and the ‘Not-secured’ state.

The ‘Not-secured’ state may be categorized into the state, the ‘Secure Associating’ state, the ‘Authenticating’ state, the ‘Authenticated’ state, and the ‘Unsecure Operating’ state.

An event, an action, and an output event for each state are illustrated n FIGS. 31 to 34.

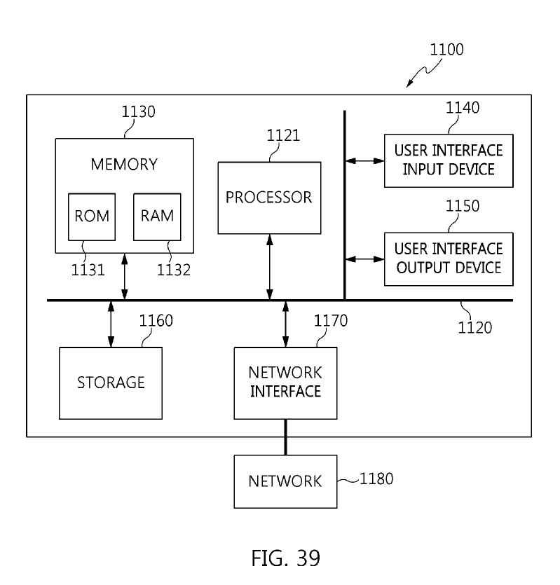

FIG. 39 is a block diagram hat shows a computer system according to an embodiment of the present invention.

Referring to FIG. 39, an embodiment of the present invention may be implemented in a computer system 1100 having a computer-readable recording medium. As illustrated in FIG. 39, the computer system 1100 may include one or more processors 1110, memory 1130, a user interface input device 1140, a user interface output device 1150, and storage 1160, which communicate with each other via a bus 1120. Also, the computer system 1100 may further include a network interface 1170 connected with a network 1180. The processor 1110 may be a central processing unit or a semiconductor device for executing processing instructions stored in the memory 1130 or the storage 1160. The memory 1130 and the storage 1160 may be various types of volatile or nonvolatile storage media. For example, the memory may include ROM 1131 or RAM 1132.

The present invention may provide security independently of a transport layer by modifying the configuration of the IEEE 11073-20601 protocol.

Also, in order to provide security independently of a transport layer, the present invention may provide mutual authentication and key exchange in which the confidentiality and integrity of a protocol are guaranteed, a message protection function, and a state machine in which a security layer is separate from other layers.

Also, the present invention may guarantee the security, privacy, and reliability of data transmitted according to the IEEE 11073-20601 protocol,

As described above, the health device, the gateway device, and the method for securing a protocol using the devices according to the present invention are not limitedly applied to the configurations and operations of the above-described embodiments, but all or some of the embodiments may be selectively combined and configured, so that the embodiments may be modified in various ways.

What is claimed is:

1. A method for securing a protocol using a health device and a gateway device, comprising::
performing, by the health device and the gateway device, authentication and key exchange based on security session information;
sending, by any one of the health device and the gateway device, an application message protected based on the security session information; and
receiving, by a remaining one of the health device and the gateway device, the protected application message.

2. The method of claim 1, wherein the security session information includes cipher suites, in which a combination of encryption algorithms to be used varies depending on a security level.

3. The method of claim 2, wherein the encryption algorithms correspond to one or more of a Pre-Shared Key (PSK) encryption algorithm, an Elliptic Curve Diffie-Hellman Ephemeral (ECDFIE)-PSK encryption algorithm, Advanced. Encryption Standard (AES), Message-Digest algorithm 5 (MD5), and Secure Hash Algorithm (SHA).

4. The method Of claim 3, wherein performing the authentication and the key exchange is configured to:
generate a premaster secret using a PSK when the authentication and the key exchange are performed based on the PSK encryption algorithm; and
generate the premaster secret using the PSK and temporary agent public key and temporary manager public key based on an ECDHE-PSK when the authentication and the key exchange are performed based on the ECDHE-PSK encryption algorithm.

5. The method of claim 4, wherein the premaster secret is configured with an octet string having a length that is equal to a sum of a length of other_secret and a length of the PSK.

6. The method of claim 5, wherein:
the length of the other_secret is equal to the length of the PSK when the authentication and the key exchange are performed based on the PSK encryption algorithm; and
the length of the other_secret is equal to a length of an octet string corresponding to a coordinate value of a point on an elliptic curve based on the temporary agent public key and the temporary manager public key when the authentication and the key exchange are performed based on the ECDHE-PSK encryption algorithm.

7. The method of claim 6, wherein performing the authentication and the key exchange is configured to generate a master secret by applying the generated premaster secret to a Pseudo Random Function (PRF).

8. The method of claim 7, wherein performing the authentication and the key exchange is configured to generate a ‘Finished’ message using the PRF based on the generated master secret and the security session information.

9. The method of claim 8, wherein performing the authentication and the key exchange is configured to generate a key block, which is separated into a Message Authentication Code (MAC) secret and an encryption key, by applying the master secret to the PRF, wherein a length of the key block is determined based on a cipher suite that is used.

10. The method of claim 9, wherein performing the authentication and the key exchange is configured such that.
the gateway device compares a manager_finished message, generated by the gateway device based on a PSK identity received from the health device, :with an agent_finished message; received from the health device;
the gateway device sends the manager_{—} finished message to the health device when it is determined that the manager_{—} finished message is identical to the agent_finished message as a result of comparison;
the health device compares the agent_finished message with the received manager_finished message; and
the authentication and the key exchange are determined to have succeeded when the health device determines that the agent_finished message is identical to the received manager_finished message as a result of comparison.

11. The method of claim 10, wherein in performing the authentication and the key exchange, an Application Association ReQuest (AARQ) and an Application Association REsponse (AARE), sent and received by the health device and the gateway device, are configured such that ‘secureassoc’, which is a message for a security protocol, is defined in ‘FunctionalUnits’ of ‘PhdAssociationInformation’.

12. The method of claim 11, wherein the AARQ and the AARE are configured such that the security session information is defined in ‘option-list’ of ‘PhdAssociationinformation’.

13. The method of claim 12, wherein the protected application message is configured such that Secure Presentation (secprst) is defined in Application Protocol Data Unit Type (ApduType).

14. The method of claim 13 wherein sending the protected application message comprises:
generating a MAC using the MAC secret;
adding the MAC to the application message;
encrypting the application message using the encryption key and an initial vector; and
sending the encrypted application message.

15. The method of claim 14, wherein generating the MAC is configured to generate the MAC by applying the MAC secret to a Hash-based Message Authentication Code (HMAC) function.

16. The method of claim 15, wherein encrypting the application message is configured to encrypt the application message using the initial vector having a length that is equal to a block length of the encryption algorithm.

17. The method of claim 16, wherein receiving the protected application message comprises:
checking a sequence number of the received application message;
decrypting the application message using the encryption key;
verifying the MAC, which is isolated from the decrypted application message, using the MAC secret; and
delivering the application message to an upper layer when the isolated MAC is verified.

18. The method of claim 17, wherein a state machine of the health device and the gateway device is configured such that the security session information is processed in a security layer that is separate from a lower layer, and the received application message is decrypted in the security layer and is then delivered to an upper layer.

19. A health device, comprising:
a communication unit for sending and receiving a message to and from a gateway device;
a message generation unit for generating an Application Association ReQuest (AARQ) based on security session information;
an authentication unit for performing authentication and key exchange based on the AARQ and an Application Association REsponse (AARE) received from the gateway device;
an encryption unit for securing an application message to be sent to the gateway device based on the security session information; and
a decryption unit for decrypting a secured application message received from the gateway device.

20. A gateway device, comprising:
a communication unit for sending and receiving a message to and from a health device;
a message generation unit for generating an Application Association REsponse (AARE) based on security session information of an Application Association ReQuest (AARQ) received from the health device;
an authentication unit for performing, authentication and key exchange based on the AARQ and the AARE;
an encryption unit for securing an application message to be sent to the health, device based on the security session information; and
a decryption unit for decrypting a secured application message received from the health device.
